(19) United States
(12) Patent Application Publication
(10) Pub. No.: US 2025/0100064 A1
(43) Pub. Date: Mar. 27, 2025

(54) JOINING OF LEAD AND LEAD ALLOYS

(71) Applicant: LEAD TECHNOLOGIES LIMITED, Barnsley, Yorkshire (GB)

(72) Inventor: Ian CRABBE, Barnsley (GB)

(21) Appl. No.: 18/727,550

(22) PCT Filed: Jan. 12, 2023
(86) PCT No.: PCT/GB2023/050053

§ 371 Date: Jul. 9, 2024

(30) Foreign Application Priority Data
Jan. 12, 2022 (GB) 2200351.1

(51) Int. Cl. B23K 9/23

(52) U.S. Cl. CPC B23K 9/232

(57) ABSTRACT

A method of joining a first metal and a second metal is described. The first metal comprises Pb in an amount of at least 50 wt. % by weight of the first metal. The method comprises fusing the first metal and the second metal using non-consumable electrode arc welding.

### FIELD

The present invention relates to the joining of lead and lead alloys, using non-consumable electrode arc welding.

### BACKGROUND TO THE INVENTION

Typically, lead and lead alloys (generally referred to as lead) are joined by lead burning. Lead burning is a manual welding process carried out by gas welding, usually using an oxy-acetylene torch. Lead burning is an homogeneous welding process, in which filler is used. Offcuts of the same lead sheet may be used as this filler, for example. For example, two pieces of lead may be formed, for example mechanically by sawing or machining and/or by casting, to contact or closely contact at a joint and then heated with the torch flame, thereby melting lead proximal the joint, including of the filler, such that the two pieces are joined by fusing. A flux is not typically used. Soldering, by contrast, uses a solder alloy that is a compatible alloy having a melting point lower than the base lead alloy.

Lead burning is preferably performed in a flat position (1: 1F or 1G), in part due to the relatively low viscosity of molten lead, which otherwise flows away from the joint. Rollers or backing strips may be used to support larger pieces during fabrication and lead burning. Other welding positions are generally avoided or not possible, due to the unavoidable flow of molten lead in other positions.

The torch used for lead burning is typically an oxy-acetylene torch. A neutral flame is typically used: a reducing flame (fuel rich) results in soot deposits (i.e. defects) in the weld while an oxidising flame burns the lead and creates lead oxide dross, leading to poor welds with low malleability, while also impairing fusion. Unlike welding of other alloys, lead burning uses a very small flame to avoid overheating adjacent areas. The flow of molten lead is controlled by the flame, which is usually handled with a semicircular or V-shaped motion. This accounts for the herringbone appearance of the lead weld. The joint is often first burned together and a filler rod added later, if additional material is needed.

When performed skillfully, the lead burning results in a joint that is rigid, strong, homogeneous and free of pinholes (i.e. defects). Burning a lead alloy that has already been used for plating, for example, such as extending an anode length, is more difficult.

While metallic lead is relatively safe to work with, lead oxide dross formed on the surface of lead is more easily absorbed by the body and thus more hazardous. Furthermore, fumes from lead welding may be hazardous to health.

That is, lead burning is a manual process, requiring skilled welders, and is relatively slow. For example, a 1 m butt joint in a 20 mm thick Pb alloy takes about 60 minutes to weld by lead burning. In addition, a close fitting initial joint (i.e. good weld preparation), having no gaps therein or perforations therethrough, is required. Additionally, defects in the weld may result from the flame and/or movement thereof while incorrect burning conditions compromise weld integrity. Further, joining of different grades of lead alloy is problematic. Furthermore, lead burning may be hazardous to health.

Hence, there is a need to improve joining of lead and lead alloys.

### SUMMARY OF THE INVENTION

It is one aim of the present invention, amongst others, to provide a method of joining lead and lead alloys which at least partially obviates or mitigates at least some of the disadvantages of the prior art, whether identified herein or elsewhere. For instance, it is an aim of embodiments of the invention to provide a method of joining lead and lead alloys that is suitable for automation and/or faster than lead burning. For instance, it is an aim of embodiments of the invention to provide a method of joining lead and lead alloys that improves joint quality, resulting in lower defect rates and/or is more reproducible. For instance, it is an aim of embodiments of the invention to provide a method of joining lead and lead alloys that is more tolerant to initial joint setup. For instance, it is an aim of embodiments of the invention to provide a method of joining lead and lead alloys that is less hazardous to health.

A first aspect provides a method of joining a first metal and a second metal, wherein the first metal comprises Pb in an amount of at least 50 wt. % by weight of the first metal, the method comprising:
fusing the first metal and the second metal using non-consumable electrode arc welding.

A second aspect provides a component, for example an anode, provided, at least in part, by joining according to the method of the first aspect.

A third aspect provides use of non-consumable electrode arc welding, for example gas tungsten arc welding or plasma arc welding, to join lead or alloys thereof.

A fourth aspect provides an apparatus for joining a first metal and a second metal, wherein the first metal comprises Pb in an amount of at least 50 wt. % by weight of the first metal, the apparatus comprising:
a non-consumable electrode arc welding unit configured to perform the method according to the first aspect; and
optionally, a first industrial robot configured to fuse the first metal and the second metal using the non-consumable electrode arc welding unit.

A fifth aspect provides a method of joining a first metal and a second metal, wherein the first metal comprises Pb in an amount of at least 50 wt. % by weight of the first metal, the method comprising:
fusing the first metal and the second metal using non-consumable electrode arc welding;
wherein fusing the first metal and the second metal using the non-consumable electrode arc welding comprises:
starting an arc of the non-consumable electrode arc welding on a third metal; and moving the started arc from the third metal to the first metal and/or to the second metal.

### DETAILED DESCRIPTION OF THE INVENTION

According to the present invention there is provided a method of joining lead and lead alloys, as set forth in the appended claims. Other features of the invention will be apparent from the dependent claims, and the description that follows.

### Method of Joining

The first aspect provides a method of joining a first metal and a second metal, wherein the first metal comprises Pb in an amount of at least 50 wt. % by weight of the first metal, the method comprising:
fusing the first metal and the second metal using non-consumable electrode arc welding.

Conventionally, non-consumable electrode arc welding, for example gas tungsten arc welding (GTAW) (also known as tungsten inert gas (TIG) welding) and plasma arc welding (PAW), is considered only suitable for joining conventional metals including steels including stainless steels, aluminium alloys, magnesium alloys, copper alloys and titanium alloys. According to expert opinion, joining of lead and lead alloys by non-consumable electrode arc welding, for example GTAW or PAW, is not possible due, at least in part, to the distinct physical and/or chemical properties of lead and lead alloys in comparison with those of the conventional metals, which are amenable to GTAW and/or PAW. Particularly, non-consumable electrode arc welding provides an intense, localised heat source that is prima facie not compatible with lead and lead alloys, due to their unique properties, as discussed below.

Contrary to expert opinion, the inventors have developed a method of joining lead and lead alloys, using non-consumable electrode arc welding, as described below in more detail. In this way, joining lead and lead alloys is suitable for automation and/or faster than lead burning. In this way, joint quality is improved, resulting in lower defect rates and/or is more reproducible. In this way, the method of joining lead and lead alloys is less hazardous to health, since the method may be automated (i.e. is non-manual) and may be performed in a protective enclosure, for example.

Without wishing to be bound by any theory, non-consumable electrode arc welding of lead and lead alloys may be problematic due, at least in part, to one or more of the physical properties of lead and lead alloys including the relatively low melting point, the latent heat of fusion, the electrical resistivity, the thermal conductivity and/or the expansion upon melting of solid lead and lead alloys and/or the viscosity, the surface tension, the electrical resistivity and/or the thermal conductivity of liquid lead and lead alloys and/or the diamagnetic properties of lead and lead alloys, as described below in more detail. Additionally and/or alternatively, oxidation of the liquid lead and lead alloys may, if not controlled, result in lack of fusion or oxide inclusions, resulting in weld defects.

### First Metal and Second Metal

It should be understood that the first metal and the second metal are provided as components or parts thereof. In one example, the first metal and/or the second metal comprises and/or is a casting, an extrusion, a slab, a plate, a sheet, a section such as a hollow section or a solid section or a bar or a machined or partially-machine component. In one example, the first metal and/or the second is provided as a coating on a component, for example on a dissimilar metal.

It should be understood that the first metal and the second metal may have the same or different compositions. It should be understood that the first metal is Pb or an alloy thereof (i.e. a lead-based alloy), comprising Pb in an amount of at least 50 wt. % by weight of the first metal. It should be understood that the second metal may not be Pb or an alloy thereof, and may be instead, for example an iron-based alloy. That is, the method according to the first aspect is suitable for both mutually joining lead or alloys thereof and also for joining lead or alloys thereof to another metal, for example as a cladding thereon.

In one example, the first metal comprises Pb in an amount of at least 75 wt. %, preferably at least 80 wt. %, more preferably at least 85 wt. %, even more preferably at least 90 wt. %, most preferably at least 95 wt. %, as described below in more detail. In one example, the first metal comprises Pb in an amount of at most 80 wt. %, preferably at most 85 wt. %, more preferably at most 90 wt. %, even more preferably at most 95 wt. %, most preferably at most 97.5 wt. %, as described below in more detail.

In one example, the second metal comprises Pb in an amount of at least 50 wt. % by weight of the second metal, at least 75 wt. %, preferably at least 80 wt. %, more preferably at least 85 wt. %, most preferably at least 90 wt. %, as described below in more detail. In one example, the second metal comprises Pb in an amount of at most 80 wt. %, preferably at most 85 wt. %, more preferably at most 90 wt. %, even more preferably at most 95 wt. %, most preferably at most 97.5 wt. %, as described below in more detail.

In one example, the first metal and/or the second metal consists of:
Ag in an amount from 0.0 to 2 wt. %, preferably 0.1 to 1.75 wt. %, more preferably from 0.25 to 1.5 wt. %, most preferably from 0.5 to 1.0 wt. %;
Ca in an amount from 0.0 to 1 wt. %, preferably 0.01 to 0.50 wt. %, more preferably from 0.02 to 0.25 wt. %, most preferably from 0.03 to 0.15 wt. %;
Sb in an amount from 0.0 to 25 wt. %, preferably from 0.25 to 15 wt. %, more preferably from 1 to 10 wt. %, most preferably 2 to 6 wt. %;
Sn in an amount from 0.0 to 10 wt. %, preferably from 0.1 to 5 wt. %, more preferably from 0.5 to 4 wt. %, most preferably 1 to 2 wt. %; and balance Pb and unavoidable impurities, as described below in more detail.

### Properties of Lead and Lead Alloys

The properties of lead that make it useful in a wide variety of applications are density, malleability, lubricity, flexibility, electrical conductivity, and coefficient of thermal expansion, all of which are relatively high compared with the conventional metals described above; and elastic modulus, elastic limit, strength, hardness, and melting point, all of which are relatively low compared with the conventional metals described above. However, these properties may make non-consumable electrode arc welding of lead problematic.

Lead also has good resistance to corrosion under a wide variety of conditions. Lead is easily alloyed with many other metals and casts with little difficulty. The high density of lead (11.35 g/cm³, at room temperature) makes it very effective in shielding against x-rays and gamma radiation. The combination of high density, high limpness (low stiffness), and high damping capacity makes lead an excellent material for deadening sound and for isolating equipment and structures from mechanical vibrations. Malleability, softness, and lubricity are three related properties that account for the extensive use of lead in many applications. The low tensile strength and low creep strength of lead must always be considered when designing lead components. The principal limitation on the use of lead as a structural material is not its low tensile strength but its susceptibility to creep. Lead continuously deforms at low stresses and this deformation ultimately results in failure at stresses far below the ultimate tensile strength. The low strength of lead does not necessarily preclude its use. Lead products can be designed to be self-supporting, or inserts or supports of other materials can be provided. Alloying with other metals, notably calcium or antimony, is a common method of strengthening lead for many applications. When lead is used as a lining in a structure made of a stronger material, the lining can be supported by bonding it to the structure. With the development of improved bonding and adhesive techniques, composites of lead with other materials can be made. Composites have improved strength yet also retain the desirable properties of lead, for example chemical resistance.

### Thermophysical Properties of Solid Pb

Pure lead has a bright, silvery appearance with a hint of blue but tarnishes on contact with moist air, taking on a dull appearance, a hue of which depends on the prevailing conditions. Characteristic properties of lead include high density, malleability, ductility, and high resistance to corrosion due to passivation.

The close-packed face-centered cubic structure and high atomic weight of lead result in a density of 11.34 g·cm⁻³, which is greater than that of common metals such as aluminium (2.7 g·cm⁻³), iron (7.87 g·cm⁻³), copper (8.93 g·cm⁻³), and zinc (7.14 g·cm⁻³).

Lead is a very soft metal with a Mohs hardness of 1.5, is quite malleable and somewhat ductile. The Young's modulus of lead is about 16 GPa and the bulk modulus of lead is about 45.8 GPa. In comparison, the Young's modulus of aluminium is 75.2 GPa; copper 137.8 GPa; and mild steel 160-169 GPa. The tensile strength of lead, at 12-17 MPa, is low: the tensile strength of aluminium is 6 times higher, copper 10 times, and mild steel 15 times higher. Lead, however, may be strengthened by alloying for example by adding small amounts of copper or antimony, for example.

The electrical resistivity of lead at 20° C. is about 192 about nΩ·m, almost an order of magnitude higher than the electrical resistivity of other industrial metals (copper: 15.43 nΩ·m; gold: 20.51 nΩ·m; and aluminium: at 24.15 nΩ·m) and higher than that of carbon steel (about 143 nΩ·m). The relatively high electrical resistivity, optionally in combination with other physical properties, may affect non-consumable electrode arc welding of lead and lead alloys, for example due to increased heating caused by current flow therethrough.

The thermal conductivity of lead is about 35.3 W·m⁻¹·K⁻¹, similar to that of carbon steel (about 36 to 54 W·m⁻¹·K⁻¹) but about an order of magnitude lower than that of aluminium (237 W·m⁻¹·K⁻¹). The thermal conductivity, optionally in combination with other physical properties, may affect non-consumable electrode arc welding of lead and lead alloys, for example due to increased temperature gradients therein, resulting in localised melting.

Lead is diamagnetic and has a magnetic susceptibility of about −23×10⁻⁶ cm³ mol⁻¹ at 298 K. In contrast, aluminium is paramagnetic while iron is ferromagnetic. The magnetic susceptibility, optionally in combination with other physical properties, may affect non-consumable electrode arc welding of lead and lead alloys, for example affecting mixing of molten lead due to current flow therethrough.

### Thermophysical Properties of Liquid Pb

Lead has a latent heat of fusion of 4.77 kJ·mol⁻¹. In contrast, iron has a latent heat of fusion of 13.81 kJ·mol⁻¹ (i.e. about three times greater) while aluminium has a latent heat of fusion of 10.71 kJ·mol⁻¹ (i.e. more than two times greater). The relatively low latent heat of fusion of lead means that only a relatively low heat input is required in order to melt the first metal and/or the second metal, thereby compounding problems for joining of lead and lead alloys

The melting point of lead, about 327.5° C. (621.5° F.), is very low compared to most metals. In contrast, aluminium has a melting point of 660.32° C. (1220.58° F.) and iron has a melting point of 1538° C. (2800° F.). The boiling point of lead of 1749° C. (3180° F.) is the lowest among the carbon group elements. Hence, not only is the latent heat of fusion of lead relatively low but the melting point of lead is also relatively low. That is, a relatively low heat input at a relatively low temperature is sufficient to melt the first metal and/or the second metal, thereby compounding problems for joining of lead and lead alloys.

The density of liquid lead at its melting point is about 10.66 g·cm³ (i.e. a reduction of about 6%). In contrast, the density of liquid iron at its melting point is about 6.98 g·cm³ (i.e. a reduction of about 11%) and the density of liquid aluminium at its melting point is about 2.375 g·cm⁻³ (i.e. a reduction of about 12%). The relatively high density of liquid lead, optionally in combination with the viscosity and/or surface tension thereof, may result in undesired flow of the liquid lead during joining of lead and lead alloys.

Thermophysical properties of liquid Pb are detailed in Vitaly Sobolev (2011) Database of thermophysical properties of liquid metal coolants for GEN-IV: Sodium, lead, lead-bismuth eutectic (and bismuth), November 2010 (rev. December 2011), SCK•CEN-BLG-1069 and summarized below.

### Melting Point of Pb and Pb Alloys

The most probable value for the melting temperature T_{M,0(Pb)} of technically pure lead is:

$${T}_{M , 0 ( P b )} = 600.6 \pm 0.1 K = 327.4 \pm 0.1 ° C .$$

Similar to the majority of metals with the face centred cubic crystal structure, lead exhibits a volume increase upon melting. At normal conditions, a volume increase of 3.81% has been observed in pure lead. In several engineering handbooks, a value of ˜3.6% is often given for lead of technical purity.

FIG. 1 shows the melting point of binary Pb alloys as a function of the content of alloying additions of Sn, Bi, Te, Ag, Na, Cu and Sb. For relatively low alloying additions (up to 10 wt. %), common alloying additions Sn, Bi and Sb depress the relatively low melting point of pure lead, further compounding problems for joining of lead alloys, since relatively low heat inputs, even non-deliberate, cause melting of the lead alloys. For example, burn through (in which the first metal and/or the second metal are perforated due to through-thickness melting) is a problem during joining that requires significant remediation and/or results in wastage of the first metal and/or the second metal. For example, controlling the temperature of the molten lead, for example by controlling heat input, so as to control temperature distribution within the weld pool and/or melting of solid lead adjacent thereto, may be important.

### Viscosity of Pb and Pb Alloys

Accurate and reliable data on viscosity of liquid metals are not abundant. Some discrepancies between experimental data can be attributed to a high reactivity of molten lead and lead alloys, to the difficulty of taking precise measurements at elevated temperatures, and to a lack of rigorous formulae for calculations. All considered liquid metals and alloys thereof are believed to be Newtonian liquids. The temperature dependence of their dynamic viscosity η is often described by an Arrhenius type equation:

$$η = {η}_{0} exp ( \frac{{E}_{η}}{R T} )$$

where E_{η} is the activation energy of motion for viscous flow and the other terms have their usual meanings.

FIG. 2 shows the dynamic viscosity η_{Pb} of technically pure liquid lead as a function of temperature from T_{M,0(Pb)} to 1470 K (1197° C.). From values in the literature, a reliable choice of an empirical equation to describe the temperature dependence of the dynamic viscosity η_{Pb} of technically pure liquid lead can be obtained by fitting the selected values into the Arrhenius type equation of the form:

$${η}_{P b} = 4.55 \times 1 {0}^{- 4} exp ( \frac{1069}{T} )$$

This correlation is valid in the temperature range from T_{M,0(Pb)} to 1470 K (1197° C.).

The relatively low dynamic viscosity η_{Pb} of technically pure liquid lead compounds problems for joining of lead and lead alloys, since molten lead tends to flow readily, for example during burn through and/or via passageways resulting from poor weld preparation, requiring significant remediation and/or resulting in wastage of the first metal and/or the second metal. An increase in the dynamic viscosity may increase viscous stresses between layers of molten metal in weld pool, altering flow behaviour of the molten lead.

### Surface Tension of Pb and Pb Alloys

A surface tension of liquid surfaces σ is related to tendency to minimise their surface energy. The surface tension decreases with temperature and reduces to zero at the critical temperature T_{c}, where difference disappears between liquid and gas phases. According to Eötvös' law for normal liquids, this behaviour can be described by formula:

$$σ ( T ) = {k}_{σ} {V}_{μ}^{- 2 / 3} ( {T}_{c} - T )$$

where V_{μ} is the molar volume. The average value of the constant k_{σ} for the normal liquid metals is 6.4×10⁻⁸ J m⁻² K⁻¹ m^{2/3} mol^{-2/3}.

FIG. 3 shows the surface tension of liquid lead as a function of temperature from T_{M,0(Pb)} to 1300 K (1027° C.). A linear correlation from T_{M,0(Pb)} to 1300 K (1027° C.) is

$${σ}_{P b} [ {Nm}^{- 1} ] = ( 525.9 - 0.113 T ) \times 1 {0}^{- 3}$$

The relatively low surface tension of liquid lead compounds problems for joining of lead and lead alloys, since molten lead tends to wet surfaces readily, resulting in spreading of the molten lead pool. Coupled with the relatively low dynamic viscosity of molten lead, significant remediation and/or wastage of the first metal and/or the second metal may result from such effects. For example, a surface tension gradient with temperature may dominate the direction of convective flow in the weld pool due, for example, to the Marangoni effect, thereby affecting formation of the weld pool due to changes in energy transfer inside the weld pool.

### Electrical Resistivity of Pb and Pb Alloys

Metals are generally characterised by a low electrical resistance, which increases with temperature and often about doubles at melting. The electrical resistivity of liquid metals, with rare exceptions, is determined by the electron component and follows its change—it increases linearly with temperature in the region close to the melting temperature. Electron-electron interaction can make this increase stronger in some metals. At atmospheric pressure, in the most of cases, the temperature dependence of the electrical resistance of the liquid metals of interest can approximately be represented by linear or hyperbolic function in the temperature range from the normal melting point to the normal boiling point:

$$ρ = {ρ}_{0} + {a}_{e} T + {b}_{e} {T}^{2}$$

In general, the electrical resistivity of liquid metals increases when impurities are included in the melt. However, in the case of a liquid alloy that is composed of polyvalent components, the resistivity sometimes shows a negative deviation from additivity of the component resistivities.

Most experiments devoted to electrical resistance of the considered liquid metals are made in the range of temperatures from the normal melting point up to about 1300 K. In this range, the reliable data have an accuracy of 2-4%. The maximum scatter is usually associated with impurities.

FIG. 4 shows the electrical resistivity ρ_{Pb} of technically pure liquid lead as a function of temperature from T_{M,0(Pb)} to 1200 K (927° C.). The electrical resistivity ρ_{Pb} of technically pure liquid lead may be approximated as a linear function in this temperature range:

$${ρ}_{P b} [ Ω m ] = ( 67.0 + 0.0471 T ) \times 1 {0}^{- 8}$$

That is, the electrical resistivity of molten lead increases as a function of temperature. The electrical resistivity of molten lead and lead alloys may be important for non-consumable electrode arc welding. For example, the dependence of resistivity on temperature may result in a large variation of resistivity inside the weld pool, given a temperature distribution therein. This variation of resistivity may affect current flow patterns in the adjacent solid lead: current flows predominantly in the direction of arc movement in order to meet colder, better-conducting metal. Hence, arc movement and/or current asymmetry may give rise to an electromagnetic (Lorentz) force acting on the welding pool in the forward direction. At high arc speeds, the magnitude of this force may approach the value of a force pressing the pool down.

### Thermal Conductivity of Pb and Pb Alloys

The experimental determination of thermal conductivity of liquid metals is difficult because of the problems related to convection and to wetting, therefore large discrepancies exist between different sets of data. A high thermal conductivity of liquid metals is mainly due to free electrons. A simple theoretical relation exists for pure metals between electrical and thermal conductivities known as Wiedemann-Franz-Lorenz (WFL) law:

$${λ}_{e} = {L}_{0} \frac{T}{ρ}$$

where λₑ is the electronic component of thermal conductivity, p is the electrical resistivity and L₀=2.45×10⁻⁸ WΩK⁻² is the Lorenz-Sommerfeld Number.

FIG. 5 shows the thermal conductivity λ_{Pb} of technically pure liquid lead as a function of temperature from T_{M,0(Pb)} to 1400 K (1127° C.). While data close to T_{M,0(Pb)} are relatively consistent, deviations are marked at higher temperatures. A recommended linear correlation for the thermal conductivity λ_{Pb} of technically pure liquid lead is given by:

$${λ}_{P b} [ {Wm}^{- 1} {K}^{- 1} ] = 9.2 + 0.011 T$$

That is, the thermal conductivity of molten lead increases as a function of temperature. The thermal conductivity of molten lead and lead alloys may be important for non-consumable electrode arc welding. For example, controlling the temperature of the molten lead, for example by controlling heat input, so as to control temperature distribution within the weld pool and/or melting of solid lead adjacent thereto, may be important.

### Oxides of Pb and Pb Alloys

PbO forms open heating lead metal in air at about 600° C. (i.e. molten lead). PbO is also the end product of oxidation of other lead oxides:
PbO₂→Pb₁₂O₁₉ (at 293° C.)
Pb₁₂O₁₉→Pb₁₂O₁₇ (at 351° C.)
Pb₁₂O₁₇→Pb₃O₄ (at 375° C.)
Pb₃O₄→PbO (at 605° C.)

Avoiding formation of one or more of these oxides, for example PbO, may be important for non-consumable electrode arc welding, since the oxides may be inclusions in the weld, deleterious to weld properties. Hence, controlling the temperature of the molten lead, for example by controlling heat input, so as to control formation of oxides, may be important.

### Products and Applications of Lead and Lead Alloys

The most significant applications of lead and lead alloys are lead-acid storage batteries (in the grid plates, posts, and connector straps), ammunition, cable sheathing, and building construction materials (such as sheet, pipe, solder, and wool for caulking). Particularly, the largest use of lead is in the manufacture of lead-acid storage batteries. These lead-acid storage batteries include a series of grid plates made from either cast or wrought calcium lead or antimonial lead that is pasted with a mixture of lead oxides and immersed in sulfuric acid. Other important applications include counterweights, battery clamps and other cast products such as: bearings, ballast, gaskets, type metal, terneplate, and foil. Lead in various forms and combinations is finding increased application as a material for controlling sound and mechanical vibrations. Also, in many forms it is important as shielding against x-rays and, in the nuclear industry, gamma rays. In addition, lead is used as an alloying element in steel and in copper alloys to improve machinability and other characteristics, and it is used in fusible (low-melting) alloys for fire sprinkler systems.

Type metals, a class of metals used in the printing industry, generally consist of lead-antimony and tin alloys. Small amounts of copper are added to increase hardness for some applications. Lead sheathing is typically extruded around electrical power and communication cables gives the most durable protection against moisture and corrosion damage, and provides mechanical protection of the insulation. Chemical lead, 1 wt. % antimonial lead, and arsenical lead are most commonly employed for this purpose.

Lead sheet is a construction material of major importance in chemical and related industries because lead resists attack by a wide range of chemicals. Lead sheet is also used in building construction for roofing and flashing, shower pans, flooring, x-ray and gamma-ray protection, and vibration damping and soundproofing. Sheet for use in chemical industries and building construction is made from either pure lead or 6 wt. % antimonial lead. Calcium-lead and calcium-lead-tin alloys are also suitable for many of these applications.

Seamless pipe made from lead and lead alloys is readily fabricated by extrusion. Because of its corrosion resistance and flexibility, lead pipes find many uses in the chemical industry and in plumbing and water distribution system. Pipe for these applications is made from either chemical lead or 6 wt. % antimonial lead

Solders in the tin-lead system are the most widely used of all joining materials. The low melting range of tin-lead solders makes them ideal for joining most metals by convenient heating methods with little or no damage to heat-sensitive parts. Tin-lead solder alloys can be obtained with melting temperatures as low as 182° C. and as high as 315° C. Except for the pure metals and the eutectic solder with 63 wt. % Sn and 37 wt. % Pb, all tin-lead solder alloys melt within a temperature range that varies according to the alloy composition.

Lead-base bearing alloys, which are called lead-base babbitt metals, vary widely in composition but can be categorized into two groups:
1. Alloys of lead, tin, antimony, and, in many instances, arsenic
2. Alloys of lead, calcium, tin, and one or more of the alkaline earth metals

Large quantities of lead are used in ammunition for both military and sporting purposes. Alloys used for shot contain up to 8 wt. % Sb and 2 wt. % As; those used for bullet cores contain up to 2 wt. % Sb. Long terne steel sheet is carbon steel sheet that has been continuously coated by various hot dip processes with terne metal (lead with 3 to 15 wt. % Sn). Its excellent solderability and special corrosion resistance make the product well-suited for this application. Lead foil, generally known as composition metal foil, is usually made by rolling a sandwich of lead between two sheets of tin, producing a tight union of the metals. Lead alloyed with tin, bismuth, cadmium, indium, or other elements, either alone or in combination, forms alloys with particularly low melting points, known as fusible alloys. Some of these alloys, which melt at temperatures even lower than the boiling point of water, are referred to as fusible alloys.

Anodes made of lead alloys are used in the electrowinning and plating of metals such as manganese, copper, nickel, and zinc, as described below in more detail. Rolled lead-calcium-tin and lead-silver alloys are the preferred anode materials in these applications, because of their high resistance to corrosion in the sulfuric acid used in electrolytic solutions. Lead anodes also have high resistance to corrosion by seawater, making them economical to use in systems for the cathodic protection of ships and offshore rigs.

### Compositions of Lead and Lead Alloys

In one example, the first metal and/or the second metal has a composition as defined herein.

### Grades of Lead

Grades are pure lead (also called corroding lead) and common lead (both containing 99.94 wt. % min lead), and chemical lead and acid-copper lead (both containing 99.90 wt. % min lead). Lead of higher specified purity (99.99 wt. %) is also available in commercial quantities. Specifications other than ASTM B 29 for grades of pig lead include federal specification QQ-L-171, German standard DIN EN 12659 (1999), British Specification BS EN 12659:1999, Canadian Standard CSA-HP2, and Australian Standard 1812.

Corroding lead: Most lead produced in the United States is pure (or corroding) lead (99.94 wt. % min Pb). Corroding lead which exhibits the outstanding corrosion resistance typical of lead and its alloys. Corroding lead is used in making pigments, lead oxides, and a wide variety of other lead chemicals.

Chemical lead: Refined lead with a residual copper content of 0.04 to 0.08 wt. % and a residual silver content of 0.002 to 0.02 wt. % is particularly desirable in the chemical industries and thus is called chemical lead.

Copper-bearing lead provides corrosion protection comparable to that of chemical lead in most applications that require high corrosion resistance. Common lead, which contains higher amounts of silver and bismuth than does corroding lead, is used for battery oxide and general alloying.

TABLE 1
Compositions (wt. %) of pure lead according to BS EN 12659:1999.

| Indicative | 99.970 | 99.985 | 99.990 |
|---|---|---|---|
| Lead | Material No. | Material No. | Material No. |
| Content | PB970R | PB985R | PB990R |
| Ag | 0.0050 maximum | 0.0025 maximum | 0.0015 maximum |
| As | 0.0010 maximum | 0.0005 maximum | 0.0005 maximum |
| Bi | 0.030 maximum | 0.0150 maximum | 0.0100 maximum |
| Cd | 0.0010 maximum | 0.0002 maximum | 0.0002 maximum |
| Cu | 0.0030 maximum | 0.0010 maximum | 0.0005 maximum |
| Ni | 0.0010 maximum | 0.0005 maximum | 0.0002 maximum |
| Sb | 0.0010 maximum | 0.0005 maximum | 0.0005 maximum |
| Sn | 0.0010 maximum | 0.0005 maximum | 0.0005 maximum |
| Zn | 0.0005 maximum | 0.0002 maximum | 0.0002 maximum |
| Total | 0.030 | 0.015 | 0.010 |
| alloying | | | |
| content | | | |

TABLE 2
Compositions (wt. %) of pure lead ingots according to GB/T 469-2013.

| | 99.970 | 99.985 | 99.990 | 99.994 |
|---|---|---|---|---|
| | Code No. | Code No. | Code No. | Code No. |
| Pb no less than | Pb99.970 | Pb99.985 | Pb99.990 | Pb99.994 |
| Ag | 0.0050 maximum | 0.0025 maximum | 0.0015 maximum | 0.0008 maximum |
| As | 0.0010 maximum | 0.0005 maximum | 0.0005 maximum | 0.0005 maximum |
| Bi | 0.030 maximum | 0.015 maximum | 0.010 maximum | 0.004 maximum |
| Cd | 0.0010 maximum | 0.0002 maximum | 0.0002 maximum | 0.0002 maximum |
| Cu | 0.003 maximum | 0.001 maximum | 0.001 maximum | 0.001 maximum |
| Fe | 0.0020 maximum | 0.0010 maximum | 0.0010 maximum | 0.0005 maximum |
| Ni | 0.0010 maximum | 0.0005 maximum | 0.0002 maximum | 0.0002 maximum |
| Sb | 0.0010 maximum | 0.0008 maximum | 0.0008 maximum | 0.0007 maximum |
| Sn | 0.0010 maximum | 0.0005 maximum | 0.0005 maximum | 0.0005 maximum |
| Zn | 0.0005 maximum | 0.0004 maximum | 0.0004 maximum | 0.0004 maximum |
| Total | 0.030 maximum | 0.015 maximum | 0.010 maximum | 0.006 maximum |

TABLE 3
Compositions (wt. %) of refined lead according to ASTM B29-19.

| | | 99.995 UNS No. L50006 |
|---|---|---|
| Lead (min) | | Low Bismuth |
| by difference | 99.97 UNS No. L50021 | Low Silver |
| Grade | Refined Pure Lead | Pure Lead |
| Ag | 0.0075 maximum | 0.0010 maximum |
| Al | 0.0005 maximum | 0.0005 maximum |
| As | 0.0005 maximum | 0.0005 maximum |
| Bi | 0.025 maximum | 0.0015 maximum |
| Cd | 0.0005 maximum | 0.0005 maximum |
| Cu | 0.0010 maximum | 0.0010 maximum |
| Fe | 0.001 maximum | 0.0002 maximum |
| Ni | 0.0002 maximum | 0.0002 maximum |
| S | 0.001 maximum | 0.001 maximum |
| Sb | 0.0005 maximum | 0.0005 maximum |
| Se | 0.0005 maximum | 0.0005 maximum |
| Sr | 0.0005 maximum | 0.0005 maximum |
| Te | 0.0002 maximum | 0.0001 maximum |
| Zr | 0.001 maximum | 0.0005 maximum |

UNS: Unified Numbering System.

### Lead-Base Alloys

Since lead is very soft and ductile, lead is normally alloyed. Antimony, tin, arsenic, and calcium are the most common alloying elements.

Antimony: Provides hardness, rigidity and resistance to curling or sagging and is used whenever strength is required. High antimony contents, however, tend to produce excessive surface scale and a less than optimum trivalent control. Antimony has a density of 0.24 lbs. per cubic inch and a melting temperature of 1170 degrees F. Antimony generally is used to give greater hardness and strength, as in storage battery grids, sheet, pipe, and castings. Antimony contents of lead-antimony alloys can range from 0.5 to 25 wt. %, but they are usually 2 to 5 wt. %.

Tin: Adding tin to lead or lead alloys increases hardness and strength, but lead-tin alloys are more commonly used for their good melting, casting, and wetting properties, as in type metals and solders. Tin gives the alloy the ability to wet and bond with metals such as steel and copper; unalloyed lead has poor wetting characteristics. Tin combined with lead and bismuth or cadmium forms the principal ingredient of many low-melting alloys. Provides improved corrosion resistance and conductivity, reduces surface scaling and improves trivalent control. Used primarily in high fluoride baths. Tin has a density of 0.26 lbs. per cubic inch and a melting temperature of 450 degrees F.

Silver: A small amount of silver (0.5-1 wt. %) greatly extends the corrosion resistance and increases the conductivity. Due to the additional cost, this is used only where an extended anode life is required such as in very high fluoride baths.

Lead-calcium alloys have replaced lead-antimony alloys in a number of applications, in particular, storage battery grids and casting applications. These alloys contain 0.03 to 0.15 wt. % Ca. More recently, aluminum has been added to calcium-lead and calcium-tin-lead alloys as a stabilizer for calcium. Silver, bismuth and some alkaline earth metals are also added to lead-calcium alloys to improve the alloy properties and the battery performance.

Arsenical lead (UNS L50310) is used for cable sheathing. Arsenic is often used to harden lead-antimony alloys and is essential to the production of round dropped shot.

### Compositions: Designations

TABLE 4
Designations of compositions of lead and lead-base alloys
according to Unified Numbering System (UNS) designation.

| | Unified Numbering |
|---|---|
| Lead and lead-base alloys | System (UNS) designation |
| Pure leads | L50000-L50099 |
| Lead - silver alloys | L50100-L50199 |
| Lead - arsenic alloys | L50300-L50399 |
| Lead - barium alloys | L50500-L50599 |
| Lead - calcium alloys | L50700-L50899 |
| Lead - cadmium alloys | L50900-L50999 |
| Lead - copper alloys | L51100-L51199 |
| Lead - indium alloys | L51500-L51599 |
| Lead - lithium alloys | L51700-L51799 |
| Lead - antimony alloys | L52500-L53799 |
| Lead - tin alloys | L54000-L55099 |
| Lead - strontium alloys | L55200-L55299 |

TABLE 5
Assigned number ranges for lead and lead alloys according
to the Lead Industries Association.

| Designated No. | Lead-alloy system |
|---|---|
| L50000-L50099 | Pure leads |
| L50100-L50199 | Pb—Ag |
| L50200-L50299 | Pb—Al |
| L50300-L50399 | Pb—As |
| L50400-L50499 | Pb—Au |
| L50500-L50599 | Pb—Ba |
| L50600-L50699 | Pb—Bi |
| L50700-L50799 | Pb—Ca |
| L50800-L50899 | Pb—Ca |
| L50900-L50999 | Pb—Cd |
| L51000-L51099 | Pb—Co |
| L51100-L51199 | Pb—Cu |
| L51200-L51299 | Pb—Fe |
| L51300-L51399 | Pb—Ga |
| L51400-L51499 | Pb—Hg |
| L51500-L51599 | Pb—In |
| L51600-L51699 | Pb—K |
| L51700-L51799 | Pb—Li |
| L51800-L51899 | Pb—Mg |
| L51900-L51999 | Pb—Mn |
| L52000-L52099 | Pb—Na |
| L52100-L52199 | Pb—Ni |
| L52200-L52299 | Pb—O |
| L52300-L52399 | Pb—P |
| L52400-L52499 | Pb—S |
| L52500-L52599 | Pb—(<1.0%)Sb |
| L52600-L52699 | Pb—(1.0-1.99)Sb |
| L52700-L52799 | Pb—(2.0-2.99)Sb |
| L52800-L52899 | Pb—(3.0-3.99)Sb |
| L52900-L52999 | Pb—(4.0-3.99)Sb |
| L53000-L53099 | Pb—(5.0-5.99)Sb |
| L53100-L53199 | Pb—(6.0-6.99)Sb |
| L53200-L53299 | Pb—(7.0-8 99)Sb |
| L53300-L53399 | Pb—(9.0-10.99)Sb |
| L53400-L53499 | Pb—(11.0-12.99)Sb |
| L53500-L53599 | Pb—(13.0-15.99)Sb |
| L53600-L53699 | Pb—(16.0-19.99)Sb |
| L53700-L53999 | Pb—(>20%)Sb |
| L53800-L53899 | Pb—Se |
| L53900-L53999 | Pb—Si |
| L54000-L54099 | Pb—(<1.0%)Sn |
| L54100-L54199 | Pb—(1.0-1.99)Sn |
| L54200-L54299 | Pb—(2.0-3.99)Sn |
| L54300-L54399 | Pb—(4.0-7.99)Sn |
| L54400-L54499 | Pb—(8.0-11.99)Sn |
| L54500-L54599 | Pb—(12.0-15.99)Sn |
| L54600-L54699 | Pb—(16.0-19.99)Sn |
| L54700-L54799 | Pb—(20.0-27.99)Sn |
| L54800-L54899 | Pb—(28.0-37.99)Sn |
| L54900-L54999 | Pb—(38.0 -47.99)Sn |
| L55000-L55099 | Pb—(48.0-57.99)Sn |
| L55100-L55199 | Pb—(>58%)Sn |
| L55200-L55299 | Pb—Sr |
| L55300-L55399 | Pb—Te |
| L55400-L55499 | Pb—Tl |
| L55500-L55599 | Pb—Zn |
| L55600-L55699 | Pb—Zr |
| L55700-L55799 | Miscellaneous alloys not included above. |

### Anodes

In one example, the first metal and/or the second metal comprises an anode or a part thereof.

### Grades of Pure Lead and Lead Alloys Used in Industrial Anodes

Pure lead grades are called corroding lead and common lead, both including a minimum of 99.94 wt. % Pb, and chemical lead and acid-copper lead, both containing a minimum of 99.90 wt. % Pb. Lead of higher specified purity (99.99 wt. %) is commercially available but is rarely used as anodes. International specifications include ASTM B29-19 for grades of pig lead (including federal specification QQ-L-181), German Standard DIN EN 12659 (1999), British Standard BS EN 12659:1999, Canadian Standard CSA-HP2 and Australian Standard 1812. Other standards are known. Corroding lead exhibits outstanding corrosion resistance, typical of lead and alloys thereof. Chemical lead is refined lead having a residual copper content of 0.004 to 0.008 wt. % and a residual silver content of 0.002 to 0.02 wt. % and is particularly desirable in the chemical industry. Copper-bearing lead provides corrosion protection comparable to that of chemical lead in most applications requiring high corrosion resistance at higher residual contents. Common lead includes higher amounts of silver and bismuth than corroding lead. Antimonial lead includes Sb in an amount from 0.5 to 25 wt. % but usually in an amount from 2 to 5 wt. %. Sb imparts greater hardness and strength. Lead-calcium alloys have replaced lead-antimony alloys (i.e. antimonial lead) in a number of applications. These lead-calcium alloys include typically 0.3 to 0.15 wt. % Ca. In addition, aluminium may be added to lead-calcium and lead-tin-calcium alloys as a stabilizer for the calcium. Adding tin to lead or alloys thereof increases hardness and strength though lead-tin alloys are typically used for their good melting, casting and wetting properties. Tin gives an alloy the ability to wet and bond with metals such as steel and copper; unalloyed lead has poor wetting characteristics.

### CP Grade Lead

CP grade lead (99.9 wt. % chemically pure) is the basic material that is used to make the various alloys. CP lead has a density of 0.41 lbs. per cubic inch and a melting temperature of 620 degrees F.

### Lead Alloys

The anode materials are purchased from a smelter already alloyed per specification. These materials are available in ingots, cast mats, rolled sheet & bars, extruded pipe and extruded rods or wire in various sizes. Extruded and rolled forms are much denser than cast materials are and will therefore hold up much longer and are better suited for large anodes or ones that need to last for long periods of time.

There is some value in standardizing alloys and to use only one. If several alloys are used then the various forms should be marked so they are not mistakenly mixed. The plater does not normally blend their own alloys as these can be purchased already alloyed from reputable lead dealers. Lead alloys should never be obtained from a scrap dealer, however, as the quality is unknown.

Most lead alloys used for chrome plating have a density of around 0.40 lbs. per cubic inch and a melting point of 580-600 degrees F.

### Alloy #5470 (6 wt. % Antimony-94 wt. % Lead)

This is a very common alloy that is used for a majority of chrome plating anodes. The antimony provides both hardness and rigidity and is particularly well suited for large or heavy anodes. The surface film from this alloy provides reasonable control of the trivalent, but the scaling is heavier than if tin were present.

### Alloy #5520 (7 wt. % Tin-93 wt. % Lead)

Used in all type baths including high fluoride solutions. This alloy is softer than #5470 is and may sag if too heavy or too large. This alloy has an improved peroxide surface film for better trivalent control and reduced scaling.

### Alloy #5540 (2 wt. % Tin-4 wt. % Antimony-94 wt. % Lead)

This alloy provides a combination of improved rigidity and corrosion resistance. It has a better surface film than #5470 does, but not quite as good as the #5520 alloy is. It is used where a combination of optimum strength, resistance to distortion and surface film is needed.

### Alloy #5630 (0.5 wt. % Silver-4 wt. % Tin-2 wt. % Antimony-93.5 wt. % Lead)

The addition of a small amount of silver greatly improves the surface film and increases the corrosion resistance. The silver content is typically 0.5 wt. %, although it can be as high as 1 wt. % for even greater benefit. This alloy typically lasts 2-3 times longer than the others do. Obviously, the cost of the silver must be weighed against the value of the additional benefits obtained. This alloy is used primarily in very high fluoride baths.

### Applications of Industrial Anodes

Lead anodes continue to be the most common industrial anodes used worldwide for electrowinning of metals from acidic sulfate electrolytes (for example Zn, Co, Ni) and in hexavalent chromium plating, being robust and of relatively low cost, despite relatively poor electrocatalytic properties of lead and problems related to its toxicity arising from anodic dissolution. The relatively low cost of lead anodes compared with titanium-coated electrodes, for example, and service lives in a range from 1 to 3 years make lead anodes attractive. In addition, the low melting point of lead and its alloys makes it possible to recycle spent industrial anodes by simply remelting the spent electrodes and casting new anode slabs therefrom. Zinc electrowinning typically uses lead-silver alloys because cobalt additions are not suitable: the silver imparts some corrosion resistance to the base lead. Copper electrowinning uses lead-calcium-tin alloys, which is favoured over the cost of silver additions. Stabilization of lead-calcium-tin alloys is provided by the controlled addition of cobalt (II) as a depolarizer in the electrowinning electrolyte. In the electrolytic production of manganese, lead-silver anodes (typically about 1 wt. % Ag) are used.

TABLE 6
Compositions of lead and lead alloys for anodes for electrowinning

| | | Typical | | |
|---|---|---|---|---|
| | | composition, | | |
| | | balance Pb | | |
| | | plus | Effect of | |
| | | unavoidable | alloying | Electrochemical |
| Lead alloy | UNS number | impurities | addition | use |
| Pure lead, | L50000 to | >99.94 wt. % | NA | Nickel |
| corroding lead | L50099 | Pb | | electrowinning |
| | | | | (at about 200 |
| | | | | A · m⁻²) |
| Lead-silver | L50100 to | 0.25 to 0.80 | Silver increases | Zinc |
| | L50199 | wt. % Ag, | corrosion | electrowinning; |
| | | typically about | resistance and | cobalt |
| | | 0.5 wt. % Ag | oxygen | electrowinning |
| | | | overvoltage, in | |
| | | | use. | |
| Lead-tin | L54000 to | 5 to 10 wt. % Sn, | Tin increases | Cobalt |
| | L55099 | historically | mechanical | electrowinning |
| | | about 4 wt. % Sn | strength, | (at about 500 |
| | | | improves melt | A · m⁻²) |
| | | | fluidity during | |
| | | | anode casting | |
| | | | and forms | |
| | | | corrosion- | |
| | | | resistant | |
| | | | intermetallics. | |
| Antimonial lead | L52500 to | 2 to 6 wt. % Sb | Antimony | Cobalt |
| (also known as | L53799 | | increases | electrowinning; |
| hard lead) | | | stiffness, | copper |
| | | | strength, creep | electrowinning |
| | | | strength while | (at about 200 |
| | | | lowering casting | A · m⁻²) |
| | | | temperature | |
| | | | and extending | |
| | | | freezing range; | |
| | | | lowers oxygen | |
| | | | overvoltage, in | |
| | | | use. | |
| Lead-calcium-tin | L50700 to | 0.1 to 2 wt. % | Calcium imparts | Copper |
| (also known as | L50899 | Sn, 0.03 to 0.15 | corrosion | electrowinning |
| non-antimonial | | wt. % Ca | resistance and | (at about 500 |
| lead) | | | stiffness; | A · m⁻²) |
| | | | reduces oxygen | |
| | | | and hydrogen | |
| | | | overpotentials in | |
| | | | use. | |

### Non-Consumable Electrode Arc Welding

The method comprises fusing the first metal and the second metal using non-consumable electrode arc welding.

It should be understood that fusing the first metal and the second metal is by melting at least some of the first metal and optionally the second metal, for example respective parts thereof in a joint region, thereby providing a melt including the at least some of the first metal and optionally the second metal and subsequently solidifying the melt, thereby joining the first metal and the second metal.

### Welding Joints

In one example, the method comprises preparing a butt joint between the first metal and the second metal, preferably a square butt joint, more preferably a closed square butt joint, and wherein fusing the first metal and the second metal comprises fusing the prepared joint.

Generally, a welding joint is a point or an edge where two or more pieces of metal are joined together. There are five welding joint types defined according to the American Welding Society: butt, corner, edge, lap, and tee. These welding joint types may have various configurations at the joint where welding occurs.

In one example, the joint comprises and/or is a butt joint, a corner joint, an edge joint, a lap joint and/or a tee joint, preferably a butt joint.

In one example, the butt joint is a single-sided butt joint or a double-sided butt joint, preferably a double-sided butt joint.

### Butt Joints

Butt joints are welds where two pieces of metal to be joined are coplanar. Weld preparation is usually minimal and butt welds are suitable for joining relatively thin sheet metals in a single pass. Common defects include entrapment of oxide or slag, excessive porosity, or cracking. For strong welds, the goal is to use the least amount of welding material possible. Butt welds are prevalent in automated welding processes, due to their relative ease of preparation, but automated welding processes may not account for non-ideal joint preparation.

### Butt Joint Geometries

FIG. 6 shows different categories of butt joints: single welded butt joints (also known as single sided butt joints), double welded butt joint (also known as double sided butt joints), and open or closed butt joints. A single welded butt joint is the name for a joint that has only been welded from one side. A double welded butt joint is created when the weld has been welded from both sides. With double welding, the depths of each weld can vary slightly. A closed weld is a type of joint in which the two pieces that will be joined are touching during the welding process. An open weld is the joint type where the two pieces have a small gap in between them during the welding process.

In one example, the joint comprises and/or is a single welded butt joint, a double welded butt joint, an open butt joint and/or a closed butt joint, preferably a single welded, closed butt joint or a double welded, closed butt joint.

### Square Butt Joints

A square butt joint (also known as a square-groove butt joint) is a butt joint in which the two pieces of metal are flat, having parallel edges mutually spaced apart. This joint is simple to prepare, economical to use, and provides satisfactory strength, but is conventionally limited by joint thickness to about ¼ in (6.35 mm). A closed square butt joint is a type of square butt joint with no spacing between the two pieces of metal, which contact or confront. Closed square butt weld joints are common for gas and arc welding. A square butt joint may be welded in a single pass.

For thicker joints, the edge of each member of the joint must be conventionally prepared to a particular geometry, as described below, to provide accessibility for welding and to ensure the desired weld soundness and strength. The opening or gap at the root of the joint and the included angle of the groove should be selected to require the least weld metal necessary to give needed access and meet strength requirements. For such thicker joints, multiple welding passes (i.e. multi pass) are required.

### V-Joints

Single butt welds are similar to a bevel joint, but instead of only one side having the beveled edge, both sides of the weld joint are beveled. In thick metals, and when welding can be performed from both sides of the work piece, a double-V joint is used. When welding thicker metals, a double-V joint requires less filler material because there are two narrower V-joints compared to a wider single-V joint. With a single-V joint, stress tends to warp the piece in one direction when the V-joint is filled, but with a double-V-joint, there are welds on both sides of the material, having opposing stresses, straightening the material.

### J-Joints

Single-J butt welds are when one piece of the weld is in the shape of a J that easily accepts filler material and the other piece is square. A J-groove is formed either with special cutting machinery or by grinding the joint edge into the form of a J. Although a J-groove is more difficult and costly to prepare than a V-groove, a single J-groove on metal between a half an inch and three quarters of an inch thick provides a stronger weld that requires less filler material. Double-J butt welds have one piece that has a J shape from both directions and the other piece is square.

### U-Joints

Single-U butt joints are welds that have both edges of the weld surface shaped like a J, but once they come together, they form a U. Double-U joints have a U formation on both the top and bottom of the prepared joint. U-joints are the most expensive edge to prepare and weld. They are usually used on thick base metals where a V-groove would be at such an extreme angle, that it would cost too much to fill.

### T-Joints

A T-joint is formed when two bars or sheets are joined perpendicular to each other in the form of a T shape.

In one example, the joint comprises a square butt joint, a closed square butt joint, a single-bevel butt joint, a double-bevel butt joint, a single-V butt joint, a double-V butt joint, a single-J butt joint, a double-J butt joint, a single-U butt joint, a double-U butt joint, a flange butt joint and/or a flare groove butt joint, preferably a square butt joint and/or a closed square joint, more preferably a square butt joint.

In one example, the joint comprises and/or is a square butt joint and/or a closed square butt joint, more preferably a single-sided square butt joint and/or a single-sided closed square butt joint, most preferably a single-sided closed square butt joint.

### Thickness

Table 7 shows conventional thickness limitations for different joint types, for welding steel or aluminium alloys, for example.

TABLE 7
Conventional thickness limitations for different joint types,
for welding steel or aluminium alloys.

| Butt joint type | Thickness |
|---|---|
| Square joint | Up to ¼ in (6.35 mm) |
| Single-bevel joint | 3/16-⅜ in (4.76-9.53 mm) |
| Double-bevel joint | Over ⅜ in (9.53 mm) |
| Single-V joint | Up to ¾ in (19.05 mm) |
| Double-V joint | Over ¾ in (19.05 mm) |
| Single-J joint | ½-¾ in (12.70-19.05 mm) |
| Double-J joint | Over ¾ in (19.05 mm) |
| Single-U joint | Up to ¾ in (19.05 mm) |
| Double-U joint | Over ¾ in (19.05 mm) |
| Flange (edge of corner) | Sheet metals less than 12 gauge |
| | (0.1046 in or 2.657 mm) |
| Flare groove | All thickness |

In one example, the butt joint has a thickness in a range from 1 to 20 mm, preferably in a range from 2 to 15 mm, more preferably in a range from 4 to 12 mm, most preferably in a range from 6 to 10 mm, for example 7, 8 or 9 mm.

Contrary to conventional thickness limitations for square butt joints, particularly closed square butt joints, the method according to the first aspect is suitable for welding square butt joints, particularly closed square butt joints, at thicknesses of 6 mm or more, optionally in a single pass, while achieving full penetration through welds. In this way, welding efficiency is improved since joint preparation is reduced. Further, by welding in a single pass only, welding efficiency is further improved.

In one example, the non-consumable electrode arc welding comprises multi-pass welding. That is, multiple passes are required to complete the joint, for example fill the joint. In one example, the non-consumable electrode arc welding comprises a single pass welding. That is, a single pass only is required to complete the joint, for example fill the joint.

### Joint Gap

In one example, the first metal and the second metal mutually contact at the joint, for example along a range from 0% to 100%, preferably in a range from 40% to 99%, more preferably in a range from 60% to 97.5% of the length of the joint. In one example, the first metal and the second metal are mutually spaced apart by a gap at the joint, for example wherein the gap is in a range from 0.01 to 1 mm, preferably in a range from 0.05 to 0.8 mm, more preferably in a range from 0.1 to 0.5 mm, for example along a range from 0% to 100%, preferably in a range from 40% to 99%, more preferably in a range from 60% to 97.5% of the length of the joint. In this way, burning through during welding is avoided.

### Joint Alignment

In one example, respective surfaces of the first metal and the second metal are coplanar at the joint or mutually offset by a step in a range from 0 to 3 mm, preferably in a range from 1 mm to 2 mm. In this way, molten metal from the step flows into the weld, thereby providing filler, if required, while remaining autogenous, for example.

### Start and Stop Position

In one example, the method comprises starting the fusing at a distance spaced apart from an end of the joint (i.e. start position) for example wherein the distance is in a range from 1 mm to 10 mm, preferably in a range from 2 mm to 9 mm, more preferably in a range from 3 mm to 8 mm, for example 4 mm, 5 mm, 6 mm or 7 mm. Starting closer to the end of the joint may result in burning through while starting further from the end of the joint may result in insufficient penetration to the end of the joint.

In one example, the method comprises stopping the fusing at a distance spaced apart from an end of the joint (i.e. stop position) for example wherein the distance is in a range from 1 mm to 10 mm, preferably in a range from 2 mm to 9 mm, more preferably in a range from 3 mm to 8 mm, for example 4 mm, 5 mm, 6 mm or 7 mm. Stopping closer to the end of the joint may result in burning through while stopping further from the end of the joint may result in insufficient penetration to the end of the joint.

### Cold Stop

In one example, the method comprises providing a cold stop before or beyond an end of the joint, for example before the start end and/or beyond the stop end. It should be understood that a cold stop is former, for example machined from a metal having a relatively high thermal and/or electrical conductivity and a melting point higher than that of the first metal and/or the second metal, such as copper or an alloy thereof, that may be used to contain molten lead at the start end and/or the stop end of the joint and/or to control earthing and hence a direction of the plasma, for example at the start end and/or the stop end of the joint. It should be understood that the cold stop is in contact with the first metal and/or the second metal at the start end and/or the stop end of the joint. In one example, the cold stop is earthed.

### Welding Position

In one example, the method comprises non-consumable electrode arc welding the first metal and the second metal in a flat position. In this way, joint quality is enhanced.

FIG. 7 shows four welding positions (1-4) defined according to the American Welding Society, further differentiated by F (fillet) and G (groove): 1 is a flat position, either 1F or 1G; 2 is a horizontal position, either 2F or 2G; 3 is a vertical position, either 3F or 3G; and 4 is an overhead position, either 4F or 4G.

In one example, the method comprises welding in a flat position, a horizontal position, a vertical position or an overhead position, preferably in a flat or a horizontal position, more preferably in a flat position. In one example, the method comprises welding a fillet or a groove. In one preferred example, the method comprises welding a fillet in a flat position.

### Welding Speed

In one example, the method comprises non-consumable electrode arc welding, for example GTAW or PAW, at a rate in a range from 1 to 100 mm/s, preferably from 5 to 75 mm/s, more preferably from 10 to 50 mm/s, even more preferably 15 mm s⁻¹ to 35 mm s⁻¹, most preferably 20 mm s⁻¹ to 30 mm s⁻¹, for example 20 mm/s, 25 mm/s, 28 mm/s or 36 mm/s. In this way, welding efficiency is improved since welding speed is increased compared with lead burning, for example.

In one example, the method comprises non-consumable electrode arc welding, for example GTAW or PAW, initially at a relatively lower first rate and subsequently, at a relatively higher second rate, for example wherein the first rate is in a range from 1 to 75 mm/s, preferably from 5 to 50 mm/s, more preferably from 10 to 40 mm/s, most preferably from 20 mm/s to 30 mm/s, for example 28 mm/s, and wherein the second rate is in a range from 5 to 100 mm/s, preferably from 10 to 75 mm/s, more preferably from 20 to 50 mm/s, most preferably from 30 to 40 mm/s, for example 36 mm/s.

### Welding Backing

In one example, the method comprises non-consumable electrode arc welding, for example GTAW or PAW, the first metal and the second metal without welding backing. Typically, welding backing (also known as a backing weld) is used to absorb some of the heat during welding and avoid excessive melt through. For example, a metal or ceramic plate or bar or a tape may be used. However, the method according to the first aspect advantageously may avoid using any welding backing, without excessive, significant and/or any melt through. In one example, the method comprises non-consumable electrode arc welding the first metal and the second metal with welding backing, for example wherein the welding backing provides an earth electrode. In this way, the arc or plasma may be controlled.

### Electrodes

In one example, the non-consumable electrode arc welding, for example GTAW or PAW, comprises using a thoriated tungsten electrode, comprising from 1.7 to 2.2 wt. % thorium, having a diameter in a range from 1.0 mm to 3.2 mm, preferably from 1.5 mm to 3.0 mm for example 1.6 mm or 2.3 mm, a diameter at tip in a range from 0.125 mm to 1.5 mm, preferably from 0.25 mm to 1.1 mm for example 0.5 or 0.8 mm, a taper length of from 1.5 to 3 times the diameter, a constant included angle in a range from 12° to 90°, preferably from 25° to 45° for example 30° or 35° and/or a pointed or a truncated tip.

Tungsten is a rare metallic element used for manufacturing gas tungsten arc welding (GTAW) electrodes. The GTAW process relies on tungsten's hardness and high-temperature resistance to carry the welding current to the arc. Tungsten has the highest melting point of any metal, 3,410 degrees Celsius.

These non-consumable electrodes come in a variety of sizes and lengths and are composed of either pure tungsten or an alloy of tungsten and other rare-earth elements and oxides. Choosing an electrode for GTAW depends on the base material type and thickness and whether welding with alternating current (AC) or direct current (DC). The end preparation may be balled, pointed or truncated, for optimizing welding and/or preventing contamination and rework.

### Pure Tungsten (Color Code: Green)

Pure tungsten electrodes (AWS classification EWP) contain 99.50 percent tungsten, have the highest consumption rate of all electrodes, and typically are less expensive than their alloyed counterparts. These electrodes form a clean, balled tip when heated and provide great arc stability for AC welding with a balanced wave. Pure tungsten also provides good arc stability for AC sine wave welding, especially on aluminum and magnesium. Pure tungsten is not typically used for DC welding because it does not provide the strong arc starts associated with thoriated or ceriated electrodes.

### Thoriated (Color Code: Red)

Thoriated tungsten electrodes (AWS classification EWTh-2) contain a minimum of 97.30 percent tungsten and 1.70 to 2.20 percent thorium and are called 2 percent thoriated. Thoriated tungsten electrodes are commonly used due to longevity and ease of use. Thorium increases the electron emission qualities of the electrode, which improves arc starts and allows for a higher current-carrying capacity. Thoriated tungsten electrodes operate at lower temperatures, resulting in lower rates of consumption and eliminates arc wandering for greater stability. Compared with other electrodes, thoriated tungsten electrodes deposit less tungsten into the weld puddle, so they cause less weld contamination. Thoriated tungsten electrodes are used mainly for specialty AC welding (such as thin-gauge aluminum and material less than 0.060 inch) and DC welding, either electrode negative or straight polarity, on carbon steel, stainless steel, nickel, and titanium.

### Ceriated (Color Code: Orange)

Ceriated tungsten electrodes (AWS classification EWCe-2) contain a minimum of 97.30 percent tungsten and 1.80 to 2.20 percent cerium and are referred to as 2 percent ceriated. These electrodes perform best in DC welding at low current settings but can be used proficiently in AC processes. With its excellent arc starts at low amperages, ceriated tungsten has become popular in such applications as orbital tube and pipe fabricating and thin sheet metal work. Using ceriated tungsten electrodes at higher amperages is not recommended because higher amperages cause the oxides to migrate quickly to the heat at the tip, removing the oxide content and nullifying its process benefits.

### Lanthanated (Color Code: Gold)

Lanthanated tungsten electrodes (AWS classification EWLa-1.5) contain a minimum of 97.80 percent tungsten and 1.30 percent to 1.70 percent lanthanum, or lanthana, and are known as 1.5 percent lanthanated. These electrodes have excellent arc starting, a low burnoff rate, good arc stability, and excellent reignition characteristics—many of the same advantages as ceriated electrodes. Lanthanated electrodes also share the conductivity characteristics of 2 percent thoriated tungsten. In some cases, 1.5 percent lanthanated can replace 2 percent thoriated without having to make significant welding program changes. Lanthanated tungsten electrodes work well on AC or DC electrode negative with a pointed end, or they can be balled for use with AC sine wave power sources. Lanthanated tungsten maintains a sharpened point well. Unlike thoriated tungsten, these electrodes are suitable for AC welding and, like ceriated electrodes, allow the arc to be started and maintained at lower voltages. Compared with pure tungsten, the addition of 1.5 percent lanthana increases the maximum current-carrying capacity by approximately 50 percent for a given electrode size.

### Zirconiated (Color Code: Brown)

Zirconiated tungsten electrodes (AWS classification EWZr-1) contain a minimum of 99.10 percent tungsten and 0.15 to 0.40 percent zirconium. A zirconiated tungsten electrode produces an extremely stable arc and resists tungsten spitting. Zirconiated tungsten electrodes are suitable for AC welding because they retain a balled tip and have a high resistance to contamination. Its current-carrying capability is equal to or greater than that of thoriated tungsten. Zirconiated tungsten electrodes are not recommended for DC welding.

### Rare Earth (Color Code: Gray)

Rare-earth tungsten electrodes (AWS classification EWG) contain unspecified additives of rare-earth oxides or hybrid combinations of different oxides, but manufacturers are required to identify each additive and its percentage on the package. Depending on the additives, desired results can include a stable arc in both AC and DC processes, greater longevity than thoriated tungsten, the ability to use a smaller-diameter electrode for the same job, use of a higher current for a similar-sized electrode, and less tungsten spitting.

### End Preparation

Three typical choices of end preparation are balled, pointed, and truncated.

A balled tip generally is used on pure tungsten and zirconiated electrodes and is suggested for use with the AC process on sine wave and conventional square wave GTAW machines. To ball the end of the tungsten properly, simply apply the AC amperage recommended for a given electrode diameter, and a ball will form on the end of the electrode. The diameter of the balled end should not exceed 1.5 times the diameter of the electrode (for example, a ⅛-in. electrode should form a 3/16-in.-diameter end). A larger sphere at the tip of the electrode can reduce arc stability. It also can fall off and contaminate the weld.

A pointed and/or truncated tip (for pure tungsten, ceriated, lanthanated, and thoriated types) should be used for inverter AC and DC welding processes. Generally, the taper on the tungsten is ground to a distance of no more than 2.5 times the electrode diameter (for example, for a ⅛-in. electrode, grind a surface ¼ to 5/16 in. long). Grinding the tungsten to a taper eases the transition of arc starting and creates a more focused arc for better welding performance.

When welding with low current on thin material (from 0.005 to 0.040 in.), it is best to grind the tungsten to a point. A pointed tip allows the welding current to transfer in a focused arc and helps prevent thin metals, such as aluminum, from becoming distorted. Using pointed tungsten for higher-current applications is not recommended, because the higher current can blow off the tip of the tungsten and cause weld puddle contamination.

For higher-current applications, a truncated tip is preferred, having a 0.010- to 0.030-in. flat land on the end of the tungsten. This flat land helps prevent the tungsten from being transferred across the arc. It also prevents a ball from forming.

TABLE 8
Electrode diameters for different current ranges.

| | | | | Constant | |
|---|---|---|---|---|---|
| Electrode diameter | | Diameter at tip | | included | Current |
| mm | inches | mm | inches | angle/° | range/A |
| 1.0 | 0.040 | 0.125 | 0.005 | 12 | 2 to 15 |
| 1.0 | 0.040 | 0.250 | 0.010 | 20 | 3 to 30 |
| 1.6 | 1/16 | 0.500 | 0.020 | 25 | 8 to 50 |
| 1.6 | 1/16 | 0.800 | 0.030 | 30 | 10 to 70 |
| 2.4 | 3/32 | 0.800 | 0.030 | 35 | 12 to 90 |
| 2.4 | 3/32 | 1.100 | 0.045 | 45 | 15 to 150 |
| 3.2 | ⅛ | 1.100 | 0.045 | 60 | 20 to 200 |
| 3.2 | ⅛ | 1.500 | 0.060 | 90 | 25 to 250 |

TABLE 9
Preferred electrode parameters, amounts in wt. %.

| Parameter | Range | Preferred range | Value |
|---|---|---|---|
| Diameter | 1.0 mm to 3.2 | 1.5 mm to 3.0 mm | 1.6 mm |
| | mm | | |
| Diameter at tip | 125 mm to 1.5 | 0.25 mm to 1.1 mm | 0.8 mm |
| | mm | | |
| Included angle | 12° to 90° | 25° to 45° | 30° |
| Taper length | 1 to 3 × | 2 to 2.5 × diameter | 2.5 × |
| | diameter | | diameter |
| Tip geometry | Balled, pointed, | Pointed, truncated | Pointed |
| | truncated | | |
| Type | Pure, thoriated, | Thoriated, 0.8%, | 2.0% |
| | lanthanated, | 1.5%, 2.0% | thoriated |
| | ceriated, | | |
| | ziroconated, | | |
| | yttriated & | | |
| | amount e.g. | | |
| | 0.8%, 1.5%, | | |
| | 2.0% | | |

### Welding Parameters-DC GTAW

In one example, the non-consumable electrode arc welding comprises current control GTAW welding, preferably pulsed direct current (DC) control GTAW welding at a frequency in a range from 100 to 3,000 Hz, preferably from 200 Hz to 2,000 Hz, for example 400 Hz.

In one example, the non-consumable electrode arc welding comprises current control GTAW welding according to the conditions of Table 10A.

TABLE 10A
Non-consumable electrode arc DC welding parameters. Welding at a rate of from 1
to 100 mm s⁻¹, preferably from 5 to 50 mm s⁻¹, more preferably from 10 to 40 mm s⁻¹,
for example 20 mm s⁻¹, 25 mm s⁻¹, 28 mm s⁻¹or 30 mm s⁻¹.

| | | | Preferred | |
|---|---|---|---|---|
| Parameter | Description | Range | range | Value |
| Shielding | This parameter operates in GTAW modes | 0.1 to | 0.1 to 5 s | 1.1 s |
| gas pre-flow | only and is used to provide gas to the weld | 10.0 s | | |
| time | zone prior to striking the arc, once the torch | | | |
| | trigger switch has been pressed. This | | | |
| | control is used to reduce weld porosity at | | | |
| | the start of a weld. | | | |
| Start current | This parameter operates in GTAW modes | 5 to 200% | 0 to 50% of | 25% |
| AS | only and is used to set the start current for | of welding | welding | |
| | TIG. In 4T mode the Initial Current remains | current A1 | current A1 | |
| | on until the torch trigger switch is released | | | |
| | after it has been depressed. In 2T mode the | | | |
| | Initial Current remains on for the Start | | | |
| | Current Time tS and then the Up Slope | | | |
| | current ramp will commence. | | | |
| Start | This parameter operates in 2T GTAW | 0 to 20 s | 0 to 2 s | |
| Current | modes only and set the time the Start | | | |
| Time tS | Current is active, after which the Up Slope | | | |
| | current ramp will commence. | | | |
| Welding | | 3 to 300 A | 20 to 120 A | 80A |
| Current A1 | | | | |
| Trough | This parameter operates in GTAW Pulse | 1 to 200% | 50 to 90% | 80% |
| Current A2 | modes only and sets the GTAW TROUGH | of | | |
| | current. The lowest point in the pulse is | Welding | | |
| | called the Trough. | Current | | |
| | | A1 | | |
| Down Slope | This parameter operates in GTAW modes | 0 to 99% | 0 to 50% | 20% |
| Time | only and is used to set the time for the weld | | | |
| | current to ramp down to the crater current. | | | |
| | This control is used to eliminate the crater | | | |
| | that can form at the completion of a weld. | | | |
| Crater | This parameter operates in GTAW modes | 5 to 200% | 0 to 50% of | 25% |
| Current AE | only. This is the current at the end of the | of | Welding | |
| | down slope current ramp. The welding | Welding | Current A1 | |
| | current will remain at the Crater Current | Current | | |
| | value until the Crater Current Time has | A1 | | |
| | elapsed, at which time the welding current | | | |
| | will cease and the unit will enter Post Flow | | | |
| | mode. This control is used to eliminate the | | | |
| | crater that can form at the completion of a | | | |
| | weld. | | | |
| Crater | This parameter operates in GTAW modes | 0 to 20 s | 0 to 2 s | 0.2 s |
| Current | only and is used to set the time for the | | | |
| Time tE | crater current before entering post flow | | | |
| | mode. This control is used to eliminate the | | | |
| | crater that can form at the completion of a | | | |
| | weld. | | | |
| Shielding | This parameter operates in GTAW modes | 20 to | 50% to | 100% |
| Gas Post- | only and is used to adjust the post gas flow | 500% | 150% | |
| Flow time | time once the arc has extinguished. This | | | |
| | control is used to reduce oxidation of the | | | |
| | tungsten electrode. | | | |
| AC balance | This parameter operates in AC GTAW | 10 to 90% | 20% to | 35% |
| | modes and is used to set the penetration to | positive | 50% | |
| | cleaning action ratio for the AC weld | welding | | |
| | current. | Current | | |
| Electrode | 1.5 to 5.0 mm | 1.5 to 5.0 | 1.0 to 3.0 | 1.6 |
| Diameter | | mm | mm | mm |
| Pulse | This parameter sets the Pulse Frequency | 0.2 to | 200 Hz to | 1500 |
| Frequency | when in GTAW Pulse operating mode. | 2000 Hz | 2,000 Hz | Hz |
| Pulse Duty | This parameter sets the percentage “on” | 1-99% | 25 to 75% | 50% |
| Factor | time of the Pulse Frequency for welding | of | | |
| | weld current when in Pulse operating mode | Welding | | |
| | | Current | | |
| | | A1 | | |
| Ignition | The ignition peak current is set after ignition | 10 to | 50% to | 100% |
| Peak | to provide stabilisation of the arc. A different | 200% | 150% | |
| Correction | peak current is saved for each selected | | | |
| | tungsten electrode diameter. | | | |
| Slope On/ | The up slope and down slope can be | ON, OFF | ON | ON |
| Off | disabled. When this feature is set to OFF, | | | |
| | current increase, current decrease, initial | | | |
| | current and crater current are not available | | | |
| | in the main parameters. | | | |

In one preferred example, the method is of joining the first metal and the second metal, wherein the first metal comprises Pb in an amount of at least 50 wt. % by weight of the first metal;
wherein the first metal comprises Pb in an amount of at least 75 wt. %, preferably at least 80 wt. %, more preferably at least 85 wt. %, most preferably at least 90 wt. %;
wherein the second metal comprises Pb in an amount of at least 50 wt. % by weight of the second metal, at least 75 wt. %, preferably at least 80 wt. %, more preferably at least 85 wt. %, most preferably at least 90 wt. %;
wherein the method comprises:
preparing a butt joint between the first metal and the second metal, preferably a square butt joint, more preferably a closed square butt joint;
wherein the butt joint is a single-sided butt joint or a double-sided butt joint, preferably a double-sided butt joint;
wherein the butt joint has a thickness in a range from 1 to 20 mm, preferably in a range from 2 to 15 mm, more preferably in a range from 3 to 12 mm, most preferably in a range from 4 to 10 mm, for example 5, 6, 7, 8 or 9 mm;
fusing the first metal and the second metal using non-consumable electrode arc welding;
wherein the non-consumable electrode arc welding is gas tungsten arc welding;
wherein the non-consumable electrode arc welding comprises providing a protective atmosphere comprising, substantially comprising, essentially comprising or consisting of Ar and unavoidable impurities, preferably at a flow rate in a range from 1 to 20 l min⁻¹, preferably 5 to 10 l min⁻¹;
wherein the non-consumable electrode arc welding comprises current control welding, preferably pulsed direct current control welding at a frequency in a range from 1 Hz to 3,000 Hz, preferably from 2 Hz to 2,000 Hz, more preferably from 3 Hz to 500 Hz for example 4 Hz or 125 Hz, at a current in a range from 3 A to 300 A, preferably in a range from 50 A to 250 A, more preferably in a range from 100 A to 200 A, for example 150 A or 190 A;
wherein the non-consumable electrode arc welding comprises non-consumable electrode arc welding at a rate of from 1 to 100 mm s⁻¹, preferably from 5 to 50 mm s⁻¹, more preferably from 10 to 40 mm s⁻¹, for example 20 mm s⁻¹, 25 mm s⁻¹, 28 mm s⁻¹ or 30 mm s⁻¹;
wherein the non-consumable electrode arc welding comprises automated non-consumable electrode arc welding, for example using an industrial robot;
and wherein fusing the first metal and the second metal comprises fusing the prepared joint.

### Welding Parameters—AC GTAW

In one example, the non-consumable electrode arc welding comprises alternating current (AC) GTAW welding at a frequency in a range from 10 Hz to 70 Hz, preferably 20 Hz to 60 Hz, more preferably 30 Hz to 50 Hz, for example 30 Hz, 40 Hz or 50 Hz at a current in a range from 100 A to 170 A, preferably 110 A to 160 A, more preferably 120 A to 150 A, for example 120 A, 130 A, 140 A or 150 A, optionally at an AC balance in a range from 10% to 50%, preferably 10% to 40%, more preferably 10% to 30%, for example 10%, 20% or 30% optionally at an AC balance in a range from 10% to 50%, preferably 10% to 40%, more preferably 10% to 30%, for example 10%, 20% or 30%.

TABLE 10B
Non-consumable electrode arc GTAW AC welding parameters. welding at a rate of
from 1 to 100 mm s⁻¹, preferably from 5 to 50 mm s⁻¹, more preferably from 10 to 40 mm s⁻¹,
for example 20 mm s⁻¹, 25 mm s⁻¹, 28 mm s⁻¹or 30 mm s⁻¹;

| Parameter | Description | Range | Preferred range | Value |
|---|---|---|---|---|
| Shielding | This parameter operates in | 0.1 to | 0 s to 2 s, preferably 0. | 0.5 s |
| gas pre- | GTAW modes only and is used | 10.0 s | 25 s to 1 s | |
| flow time | to provide gas to the weld zone | | | |
| | prior to striking the arc, once | | | |
| | the torch trigger switch has | | | |
| | been pressed. This control is | | | |
| | used to reduce weld porosity at | | | |
| | the start of a weld. | | | |
| Start | This parameter operates in | 5 to | 70% to 120%, | 90%, |
| current AS | GTAW modes only and is used | 200% of | preferably 80% to | 92.5%, |
| | to set the start current for TIG. | welding | 110%, more preferably | 95%, |
| | In 4T mode the Initial Current | current | 90% to 100% | 97.5% |
| | remains on until the torch | A1 | | or 100% |
| | trigger switch is released after | | | |
| | it has been depressed. In 2T mode | | | |
| | the Initial Current remains on | | | |
| | for the Start Current Time tS | | | |
| | and then the Up Slope current | | | |
| | ramp will commence. | | | |
| Start | This parameter operates in 2T | 0 to 20 s | 0 to 10 s, preferably 0 | |
| Current | GTAW modes only and set the | | to 5 s, more preferably | |
| Time tS | time the Start Current is active, | | 0 to 2 s | |
| | after which the Up Slope | | | |
| | current ramp will commence. | | | |
| Welding | | 3 to 300 | 100 A to 170 A, | 120 A, |
| Current A1 | | A | preferably 110 A to | 130 A or |
| | | | 160 A, more preferably | 140 A |
| | | | 120 A to 150 A, for | |
| | | | example 120 A, 130 A, | |
| | | | 140 A or 150 A. | |
| Down | This parameter operates in | 0 to 99% | 0 to 50% | 20% |
| Slope Time | GTAW modes only and is used | | | |
| | to set the time for the weld | | | |
| | current to ramp down to the | | | |
| | crater current. This control is | | | |
| | used to eliminate the crater | | | |
| | that can form at the completion | | | |
| | of a weld. | | | |
| Crater | This parameter operates in | 5 to | 0 to 50% of Welding | 25% |
| Current AE | GTAW modes only. This is the | 200% of | Current A1 | |
| | current at the end of the down | Welding | | |
| | slope current ramp. The | Current | | |
| | welding current will remain at | A1 | | |
| | the Crater Current value until | | | |
| | the Crater Current Time has | | | |
| | elapsed, at which time the | | | |
| | welding current will cease and | | | |
| | the unit will enter Post Flow | | | |
| | mode. This control is used to | | | |
| | eliminate the crater that can | | | |
| | form at the completion of a | | | |
| | weld. | | | |
| Crater | This parameter operates in | 0 to 20 s | 0 to 2 s | 0.2 s |
| Current | GTAW modes only and is used | | | |
| Time tE | to set the time for the crater | | | |
| | current before entering post | | | |
| | flow mode. This control is used | | | |
| | to eliminate the crater that can | | | |
| | form at the completion of a | | | |
| | weld. | | | |
| Shielding | This parameter operates in | 20 to | 0.5 s to 10 s, | 100% |
| Gas Post- | GTAW modes only and is used | 500% | preferably 1 to 8 s, | |
| Flow time | to adjust the post gas flow time | | more preferably 1 to 6 | |
| | once the arc has extinguished. | | s, for example 1, 1.5, | |
| | This control is used to reduce | | 2, 3, 4, 5 or 6 s. The | |
| | oxidation of the tungsten | | weld metal solidifies | |
| | electrode. | | rapidly such that | |
| | | | lengthy shielding gas | |
| | | | post-flow is not | |
| | | | required. | |
| AC balance | This parameter operates in AC | 10 to | 10% to 50%, | 10%, |
| | GTAW modes and is used to | 90% | preferably 10% to | 20% or |
| | set the penetration to cleaning | positive | 40%, more preferably | 30% |
| | action ratio for the AC weld | welding | 10% to 30%. 20% | |
| | current. | Current | gives a good balance | |
| | | | between cleanliness | |
| | | | and penetration. | |
| AC | This parameter operates in AC | 30 Hz - | 10 Hz to 70 Hz, | 30 Hz, |
| frequency | mode only and is used to set | 200 Hz | preferably 20 Hz to 60 | 40 Hz or |
| | the frequency for the AC weld | | Hz, more preferably 30 | 50 Hz |
| | current | | Hz to 50 Hz. 30 Hz is | |
| | | | suitable for 6 mm plate | |
| | | | and 40 Hz for 8 mm | |
| | | | plate. | |
| Electrode | 1.5 to 5.0 mm | 1.5 to 5.0 | 1.5 mm to 3.0 mm | 1.6 mm |
| Diameter | | mm | | |
| Ignition | The ignition peak current is set | 10 to | 50% to 150% | 100% |
| Peak | after ignition to provide | 200% | | |
| Correction | stabilisation of the arc. A | | | |
| | different peak current is saved | | | |
| | for each selected tungsten | | | |
| | electrode diameter. | | | |
| Slope On/ | The up slope and down slope | ON, OFF | ON | ON |
| Off | can be disabled. When this | | | |
| | increase, current decrease, | | | |
| | feature is set to OFF, current | | | |
| | initial current and crater current | | | |
| | are not available in the main | | | |
| | parameters. | | | |

In one preferred example, the method is of joining the first metal and the second metal, wherein the first metal comprises Pb in an amount of at least 50 wt. % by weight of the first metal;
wherein the first metal comprises Pb in an amount of at least 75 wt. %, preferably at least 80 wt. %, more preferably at least 85 wt. %, most preferably at least 90 wt. %;
wherein the second metal comprises Pb in an amount of at least 50 wt. % by weight of the second metal, at least 75 wt. %, preferably at least 80 wt. %, more preferably at least 85 wt. %, most preferably at least 90 wt. %;
wherein the method comprises:
preparing a butt joint between the first metal and the second metal, preferably a square butt joint, more preferably a closed square butt joint;
wherein the butt joint is a single-sided butt joint or a double-sided butt joint, preferably a double-sided butt joint;
wherein the butt joint has a thickness in a range from 1 to 20 mm, preferably in a range from 2 to 15 mm, more preferably in a range from 3 to 12 mm, most preferably in a range from 4 to 10 mm, for example 5, 6, 7, 8 or 9 mm;
fusing the first metal and the second metal using non-consumable electrode arc welding;
wherein the non-consumable electrode arc welding is gas tungsten arc welding;
wherein the non-consumable electrode arc welding comprises providing a protective atmosphere comprising, substantially comprising, essentially comprising or consisting of Ar+1 to 5% H₂ and unavoidable impurities, preferably at a flow rate in a range from 1 to 30 l min⁻¹, preferably 5 to 20 l min⁻¹, for example 10 l min⁻¹ or 15 l min⁻¹;
wherein the non-consumable electrode arc welding comprises alternating current (AC) welding at a frequency in a range from 10 Hz to 70 Hz, preferably 20 Hz to 60 Hz, more preferably 30 Hz to 50 Hz, for example 30 Hz, 40 Hz or 50 Hz at a current in a range from 100 A to 170 A, preferably 110 A to 160 A, more preferably 120 A to 50 A, for example 120 A, 130 A, 140 A or 150 A optionally at an AC balance in a range from 10% to 50%, preferably 10% to 40%, more preferably 10% to 30%, for example 10%, 20% or 30%;
wherein the non-consumable electrode arc welding comprises non-consumable electrode arc welding at a rate of from 1 to 100 mm s⁻¹, preferably from 5 to 50 mm s⁻¹, more preferably from 10 to 40 mm s⁻¹, for example 20 mm s⁻¹, 25 mm s⁻¹, 28 mm s⁻¹ or 30 mm s⁻¹;
wherein the non-consumable electrode arc welding comprises automated non-consumable electrode arc welding, for example using an industrial robot;
and wherein fusing the first metal and the second metal comprises fusing the prepared joint.

### Filler

In one example, fusing the first metal and the second metal comprises autogenous fusing. That is, filler is not used.

### Shielding Gas

In one example, the non-consumable electrode arc welding comprises providing a protective atmosphere comprising, substantially comprising, essentially comprising or consisting of Ar and unavoidable impurities, preferably at a flow rate in a range from 1 to 20 l min⁻¹, preferably 5 to 10 l min⁻¹.

In one example, the non-consumable electrode arc welding comprises providing a protective atmosphere comprising, substantially comprising, essentially comprising or consisting of Ar+1 to 5% H₂ and unavoidable impurities, preferably at a flow rate in a range from 1 to 30 l min⁻¹, preferably 5 to 20 l min⁻¹, for example 15 l min⁻¹.

Although the weld metal properties are primarily controlled by the composition of the consumable, the shielding gas can influence the weld's strength, ductility, toughness and corrosion resistance.

Argon: the most commonly-used shielding gas which can be used for welding a wide range of materials including steels, stainless steel, aluminium and titanium. For example, Pureshield® Argon having a purity level of 99.998%.

Argon+1 to 5% H₂: the addition of hydrogen to argon will make the gas slightly reducing, assisting the production of cleaner-looking welds without surface oxidation. As the arc is hotter and more constricted, it permits higher welding speeds. For example, Stainshield TIG® 98.5% argon, 1.5% hydrogen; Specshield® 95% argon, 5% hydrogen.

Helium and helium/argon mixtures: adding helium to argon will raise the temperature of the arc. This promotes higher welding speeds and deeper weld penetration. Disadvantages of using helium or a helium/argon mixture is the high cost of gas and difficulty in starting the arc.

Carbon dioxide: Added in various amounts to improve the shape of the weld bead. In the welding arc, carbon dioxide dissociates into carbon monoxide and free oxygen, and it is this dissociation and recombination that adds energy into the weld pool. This energy melts more of the parent material, improving the fusion characteristics of the weld. The higher the level of carbon dioxide in the shielding gas, the larger and more rounded the weld-bead penetration area becomes.

Oxygen: Added to reduce the surface tension of the molten metal and reduce droplet sizes. By reducing the surface tension, it allows the weld bead to spread out or ‘wet in’, lowering the height of the reinforcement. This not only uses less welding wire, lowering the cost, it also reduces the stress at the toe of the weld where cracks can occur.

### Gas Tungsten Arc Welding

In one example, the non-consumable electrode arc welding is gas tungsten arc welding, for example at conditions as described herein.

Generally, gas tungsten arc welding (GTAW), also known as tungsten inert gas (TIG) welding, is an arc welding process that uses a non-consumable tungsten electrode to produce the weld. The weld area and electrode are protected from oxidation or other atmospheric contamination by an inert shielding gas (argon or helium), and a filler metal is normally used, though some welds, known as autogenous welds, do not require it. A constant-current welding power supply produces electrical energy, which is conducted across the arc through a column of highly ionized gas and metal vapours known as a plasma.

GTAW is most commonly used to weld thin sections of stainless steel and non-ferrous metals such as aluminium, magnesium, and copper alloys. The process grants the operator greater control over the weld than competing processes such as shielded metal arc welding and gas metal arc welding, allowing for stronger, higher quality welds. However, GTAW is comparatively more complex and difficult to master, and furthermore, it is significantly slower than most other welding techniques. A related process, plasma arc welding, uses a slightly different welding torch to create a more focused welding arc and as a result is often automated.

Manual gas tungsten arc welding is a relatively difficult welding method, due to the coordination required by the welder. Similar to torch welding, GTAW normally requires two hands, since most applications require that the welder manually feed a filler metal into the weld area with one hand while manipulating the welding torch in the other. Maintaining a short arc length, while preventing contact between the electrode and the workpiece, is also important.

To strike the welding arc, a high frequency generator (similar to a Tesla coil) provides an electric spark. This spark is a conductive path for the welding current through the shielding gas and allows the arc to be initiated while the electrode and the workpiece are separated, typically about 1.5-3 mm (0.06-0.12 in) apart.

Once the arc is struck, the welder moves the torch in a small circle to create a welding pool, the size of which depends on the size of the electrode and the amount of current. While maintaining a constant separation between the electrode and the workpiece, the operator then moves the torch back slightly and tilts it backward about 10-15 degrees from vertical. Filler metal is added manually to the front end of the weld pool as it is needed.

Generally, the equipment required for the gas tungsten arc welding operation includes a welding torch, for example a water-cooled torch, utilizing a non-consumable tungsten electrode, a constant-current welding power supply, and a shielding gas source.

GTAW welding torches are designed for either automatic or manual operation and are equipped with cooling systems using air or water. The automatic and manual torches are similar in construction, but the manual torch has a handle while the automatic torch normally comes with a mounting rack. The angle between the centreline of the handle and the centreline of the tungsten electrode, known as the head angle, can be varied on some manual torches according to the preference of the operator. Air cooling systems are most often used for low-current operations (up to about 200 A), while water cooling is required for high-current welding (up to about 600 A). The torches are connected with cables to the power supply and with hoses to the shielding gas source and where used, the water supply. In one example, the non-consumable electrode arc welding comprises automated non-consumable electrode arc welding, for example using an industrial robot. In one example, the GTAW is automated, for example using an industrial robot. In this way, weld productivity and/or reproducibility is improved. In one example, the GTAW uses is water-cooled welding torch. In this way, weld stability is improved.

The internal metal parts of a torch are made of hard alloys of copper or brass so it can transmit current and heat effectively. The tungsten electrode must be held firmly in the centre of the torch with an appropriately sized collet, and ports around the electrode provide a constant flow of shielding gas. Collets are sized according to the diameter of the tungsten electrode they hold. The body of the torch is made of heat-resistant, insulating plastics covering the metal components, providing insulation from heat and electricity to protect the welder.

Generally, gas tungsten arc welding uses a constant current power source, meaning that the current (and thus the heat) remains relatively constant, even if the arc distance and voltage change. This is important because most applications of GTAW are manual or semiautomatic, requiring that an operator hold the torch. Maintaining a suitably steady arc distance is difficult if a constant voltage power source is used instead, since it can cause dramatic heat variations and make welding more difficult.

The preferred polarity of the GTAW system depends largely on the type of metal being welded. Direct current with a negatively charged electrode (DCEN) is often employed when welding steels, nickel, titanium, and other metals. It can also be used in automatic GTAW of aluminium or magnesium when helium is used as a shielding gas. The negatively charged electrode generates heat by emitting electrons, which travel across the arc, causing thermal ionization of the shielding gas and increasing the temperature of the base material. The ionized shielding gas flows toward the electrode, not the base material, and this can allow oxides to build on the surface of the weld. Direct current with a positively charged electrode (DCEP) is less common and is used primarily for shallow welds since less heat is generated in the base material. Instead of flowing from the electrode to the base material, as in DCEN, electrons go the other direction, causing the electrode to reach very high temperatures. To help it maintain its shape and prevent softening, a larger electrode is often used. As the electrons flow toward the electrode, ionized shielding gas flows back toward the base material, cleaning the weld by removing oxides and other impurities and thereby improving its quality and appearance.

Alternating current, commonly used when welding aluminium and magnesium manually or semi-automatically, combines the two direct currents by making the electrode and base material alternate between positive and negative charge. This causes the electron flow to switch directions constantly, preventing the tungsten electrode from overheating while maintaining the heat in the base material. Surface oxides are still removed during the electrode-positive portion of the cycle and the base metal is heated more deeply during the electrode-negative portion of the cycle. Some power supplies enable operators to use an unbalanced alternating current wave by modifying the exact percentage of time that the current spends in each state of polarity, giving them more control over the amount of heat and cleaning action supplied by the power source. In addition, operators must be wary of rectification, in which the arc fails to reignite as it passes from straight polarity (negative electrode) to reverse polarity (positive electrode). To remedy the problem, a square wave power supply can be used, as can high-frequency to encourage arc stability.

### Plasma Arc Welding

In one example, the non-consumable electrode arc welding is plasma arc welding, for example at conditions as described herein.

Generally, plasma arc welding (PAW) is an arc welding process similar to gas tungsten arc welding (GTAW). The electric arc is formed between an electrode (which is usually but not always made of sintered tungsten) and the workpiece. The key difference from GTAW is that in

PAW, by positioning the electrode within the body of the torch, the plasma arc can be separated from the shielding gas envelope. The plasma is then forced through a fine-bore copper nozzle which constricts the arc and the plasma exits the orifice at high velocities (approaching the speed of sound) and a temperature approaching 28,000° C. or higher.

Plasma arc welding is a constricted arc process. The arc is constricted with the help of a water-cooled small diameter nozzle which squeezes the arc, increases its pressure, temperature and heat intensely and thus improves arc stability, arc shape and heat transfer characteristics. Plasma arc welding processes can be divided into two basic types: non-transferred arc process and transferred arc process.

In a non-transferred arc process, the arc is formed between the electrode (−) and the water cooled constricting nozzle (+). Arc plasma comes out of the nozzle as a flame. The arc is independent of the work piece and the work piece does not form a part of the electrical circuit. Just like an arc flame (as in atomic hydrogen welding), it can be moved from one place to another and can be better controlled. The non-transferred plasma arc possesses comparatively less energy density as compared to a transferred arc plasma and it is employed for welding and in applications involving ceramics or metal plating (spraying). High density metal coatings can be produced by this process. A non-transferred arc is initiated by using a high frequency unit in the circuit.

In a transferred arc process, the arc is formed between the electrode (−) and the work piece (+). In other words, arc is transferred from the electrode to the work piece. A transferred arc possesses high energy density and plasma jet velocity. For this reason, it is employed to cut and melt metals. Besides carbon steels this process can cut stainless steel and nonferrous metals where an oxyacetylene torch does not succeed. Transferred arc can also be used for welding at high arc travel speeds. For initiating a transferred arc, a current limiting resistor is put in the circuit, which permits a flow of about 50 amps, between the nozzle and electrode and a pilot arc is established between the electrode and the nozzle. As the pilot arc touches the job main current starts flowing between electrode and job, thus igniting the transferred arc. The pilot arc initiating unit gets disconnected and pilot arc extinguishes as soon as the arc between the electrode and the job is started. The temperature of a constricted plasma arc may be of the order of 8,000-25,000° C.

Generally, the equipment required for plasma arc welding is similar to that for gas tungsten arc welding operation mutatis mutandis.

A direct current power source (generator or rectifier) having drooping characteristics and open circuit voltage of 70 volts or above is suitable for plasma arc welding. Rectifiers are generally preferred over DC generators. Working with helium as an inert gas needs open circuit voltage above 70 volts. This higher voltage can be obtained by series operation of two power sources; or the arc can be initiated with argon at normal open circuit voltage and then helium can be switched on.

Two inert gases or gas mixtures are employed. The orifice gas at lower pressure and flow rate forms the plasma arc. The pressure of the orifice gas is intentionally kept low to avoid weld metal turbulence, but this low pressure is not able to provide proper shielding of the weld pool. To have suitable shielding protection same or another inert gas is sent through the outer shielding ring of the torch at comparatively higher flow rates. Most of the materials can be welded with argon, helium, argon+hydrogen and argon+helium, as inert gases or gas mixtures. Argon is very commonly used. Helium is preferred where a broad heat input pattern and flatter cover pass is desired without key hole mode weld. A mixture of argon and hydrogen supplies heat energy higher than when only argon is used and thus permits keyhole mode welds in nickel base alloys, copper base alloys and stainless steels.

Typical welding parameters for conventional plasma arc welding of ferrous alloys are as follows:

Current 50 to 350 amps, voltage 27 to 31 volts, gas flow rates 2 to 40 liters/minute (lower range for orifice gas and higher range for outer shielding gas), direct current electrode negative (DCEN) is normally employed for plasma arc welding except for the welding of aluminum in which cases water cooled electrode is preferable for reverse polarity welding, i.e. direct current electrode positive (DCEP).

In contrast, PAW welding of lead or alloys thereof maybe at relatively lower currents. In one example, the non-consumable electrode arc welding is DC PAW. In one example, the non-consumable electrode arc welding is pulsed DC PAW. In one example, the pulsed DC PAW at a current in a range from 0.1 to 50 A, preferably in a range from 1 A to 20 A, more preferably in a range from 2 A to 15 A, most preferably in a range from 4 A to 10 A. In one example, the PAW welding, for example pulsed DC PAW welding, is at a speed in a range from 0.5 mm s⁻¹ to 20 mm s⁻¹, preferably in a range from 1 mm s⁻¹ to 10 mm s⁻¹, more preferably in a range from 2 mm s⁻¹ to 5 mm s⁻¹, for example 3 mm s⁻¹. In one example, the PAW welding, for example pulsed DC PAW welding, is at a gas flow rate in a range from 0.1 to 5 L min⁻¹, preferably from 0.3 to 3 L min⁻¹, more preferably in a range from 0.6 to 1 L min⁻¹.

### Starting the Arc

The fifth aspect provides a method of joining a first metal and a second metal, wherein the first metal comprises Pb in an amount of at least 50 wt. % by weight of the first metal, the method comprising:
fusing the first metal and the second metal using non-consumable electrode arc welding;
wherein fusing the first metal and the second metal using the non-consumable electrode arc welding comprises:
starting an arc of the non-consumable electrode arc welding on a third metal; and
moving the started arc from the third metal to the first metal and/or to the second metal.

In this way, fusing the first metal and the second metal using the non-consumable electrode arc welding is improved relatively because the arc is started on the metal and the started arc moved from the third metal to the first metal and/or to the second metal, to thereby fuse the first metal and the second metal. Particularly, the inventors have identified that a stability of the non-consumable electrode arc welding and/or a quality of the fusing of the first metal and the second metal is improved, for example at least proximal a start of the joint, compared with starting the arc on the first metal and/or the second metal. It should be understood that the started arc is maintained during the moving.

In one example, the third metal is electrically coupled to the first metal and/or wherein the third metal is electrically coupled to the second metal, for example via an earth lead, a backing plate and/or a substrate, such as a welding table. In this way, stability of the of the arc is improved, for example during the moving the started arc from the third metal to the first metal and/or to the second metal.

In one example, the first metal and the third metal are mutually spaced apart and/or wherein the second metal and the third metal are mutually spaced apart, for example by a ap in a range from 1 mm to 100 mm, preferably in a range from 10 mm to 75 mm, more preferably in a range from 25 mm to 60 mm, for example 30 mm, 40 mm or 50 mm. That is, the first metal and the third metal and/or the second metal and the third metal are not physically in direct contact. In other words, the gap (i.e. a spacing) is disposed between the first metal and the third metal and/or between the second metal and the third metal and moving the started arc from the third metal to the first metal and/or to the second metal comprises moving the started arc from the third metal to the first metal and/or to the second metal across the gap. In this way, contamination from the third metal to the non-consumable electrode arc welding of the first metal and the second metal is avoided.

In one example, the third metal comprises Pb in an amount of at most 25 wt. %, preferably at most 20 wt. %, more preferably at most 15 wt. %, most preferably at most 10 wt. %. In this way, starting the arc is improved compared with starting the arc on the first metal, for example.

In one example, the third metal comprises and/or is: a steel for example a low alloy steel such as mild steel or a stainless steel; an aluminium alloy; a magnesium alloy; a copper alloy; and/or a titanium alloy. That is, the third metal comprises and/or is a conventional metal for joining using non-consumable electrode arc welding. In this way, starting the arc is improved compared with starting the arc on the first metal, for example.

In one example, the third metal comprises and/or is a polished and/or machined region of the first metal and/or the second metal. In this way, starting the arc is improved compared with an as-received machined region of the first metal and/or the second metal.

In one example, the third metal and the first metal are different. In one example, the third metal and the second metal are different.

In one example, the method comprises melting the third metal, for example along a path in a range from 1 mm to 100 mm, preferably in a range from 10 mm to 75 mm, more preferably in a range from 25 mm to 60 mm, for example 30 mm, 40 mm or 50 mm.

In one example, a ratio of a rate of non-consumable electrode arc welding of the third metal to a rate of non-consumable electrode arc welding of the first metal and the second metal is in a range from 10:1 to 1:10, preferably in a range from 5:1 to 1:5, more preferably in a range from 2:1 to 1:2, most preferably in a range from 3:2 to 2:3, for example about 1:1 or 1:1. That is, a speed of non-consumable electrode arc welding on the third metal may be faster, similar to, or slower than of the non-consumable electrode arc welding of the first metal and the second metal, preferably similar.

In one example, a ratio of a rate of moving the started arc from the third metal to the first metal and/or to the second metal to a rate of non-consumable electrode arc welding of the first metal and the second metal is in a range from 50:1 to 1:1, preferably in a range from 25:1 to 3:2, more preferably in a range from 10:1 to 2:1, most preferably in a range from 5:1 to 5:2. That is, the started arc is moved relatively quickly from the third metal to the first metal and/or to the second metal.

In one example, moving the started arc from the third metal to the first metal and/or to the second metal comprises raising the started arc from the third metal (i.e. raising from a welding electrode height, for example by increasing the welding electrode height in a range from 1 mm to 50 mm, preferably in a range from 5 mm to 25 mm, more preferably in a range from 10 mm to 20 mm), moving the started arc from the third metal to the first metal and/or to the second metal, for example across a gap, and lowering the started arc to the first metal and/or to the second metal (i.e. lowering to a welding electrode height).

The first metal, the second metal and/or the fusing the first metal and the second metal using the non-consumable electrode arc welding may be as described with respect to the first aspect and/or comprise any step as described with respect to the first aspect.

### Component

The second aspect provides a component, for example an anode, provided, at least in part, by joining according to the method of the first aspect.

### Use

The third aspect provides use of non-consumable electrode arc welding, for example gas tungsten arc welding or plasma arc welding, to join lead or alloys thereof, for example as described with respect to the first aspect.

### Apparatus

The fourth aspect provides an apparatus for joining a first metal and a second metal, wherein the first metal comprises Pb in an amount of at least 50 wt. % by weight of the first metal, the apparatus comprising:
a non-consumable electrode arc welding unit configured to perform the method according to the first aspect; and
optionally, a first industrial robot configured to fuse the first metal and the second metal using the non-consumable electrode arc welding unit.

The first metal, the second metal and/or the fusing may be as described with respect to the first aspect.

In one example, the non-consumable electrode arc welding unit, for example a GTAW unit such as a TWECO® ARCMASTER® 301TS or a PAW unit such as a Fronius® PlasmaModule 10®. Other GTAW and PAW units are known.

It should be understood that the first industrial robot is configured to move the non-consumable electrode arc welding torch. In this way, the welding is automated. In one example, the first industrial robot comprises an articulated robot, for example having a pay load in a range from 3 kg to 500 kg and/or a reach in a range in from 0.5 m to 4 m. Suitable industrial robots are available from ABB Ltd (Zurich, Switzerland). In one example, the non-consumable electrode arc welding unit and the first industrial robot are communicatively coupled, for example bi-directionally. In this way, the first industrial robot may control the non-consumable electrode arc welding unit.

In one example, the apparatus comprises a positioner, such as an automated table, for holding the first metal and a second metal during fusing. In one example, the apparatus comprises a second industrial robot configured to load the first metal and the second metal on the positioner and unload the fused first metal and second metal therefrom. In one example, the positioner includes a first table to receive the first metal and the second metal and a second table, similar to the first table. In this way, fusing and loading or unloading may be performed simultaneously by respectively by the first and second industrial robots. In one example, the first industrial robot, or a controller thereof, is configured to control the non-consumable electrode arc welding unit, optionally the positioner and/or the second industrial robot.

### Definitions

Throughout this specification, the term “comprising” or “comprises” means including the component(s) specified but not to the exclusion of the presence of other components. The term “consisting essentially of” or “consists essentially of” means including the components specified but excluding other components except for materials present as impurities, unavoidable materials present as a result of processes used to provide the components, and components added for a purpose other than achieving the technical effect of the invention, such as colourants, and the like. The term “consisting of” or “consists of” means including the components specified but excluding other components. Whenever appropriate, depending upon the context, the use of the term “comprises” or “comprising” may also be taken to include the meaning “consists essentially of” or “consisting essentially of”, and also may also be taken to include the meaning “consists of” or “consisting of”. The optional features set out herein may be used either individually or in combination with each other where appropriate and particularly in the combinations as set out in the accompanying claims. The optional features for each aspect or exemplary embodiment of the invention, as set out herein are also applicable to all other aspects or exemplary embodiments of the invention, where appropriate. In other words, the skilled person reading this specification should consider the optional features for each aspect or exemplary embodiment of the invention as interchangeable and combinable between different aspects and exemplary embodiments.

### BRIEF DESCRIPTION OF THE DRAWINGS

For a better understanding of the invention, and to show how exemplary embodiments of the same may be brought into effect, reference will be made, by way of example only, to the accompanying diagrammatic Figures, in which:

FIG. 1 shows the melting point of binary Pb alloys as a function of the content of alloying additions of Sn, Bi, Te, Ag, Na, Cu and Sb;

FIG. 2 shows the dynamic viscosity η_{Pb} of liquid lead as a function of temperature;

FIG. 3 shows the surface tension of liquid lead as a function of temperature;

FIG. 4 shows the electrical resistivity ρ_{Pb} of liquid lead as a function of temperature;

FIG. 5 shows the thermal conductivity λ_{Pb} of liquid lead as a function of temperature;

FIG. 6 schematically depicts different categories of butt joints;

FIG. 7 schematically depicts welding positions defined according to the American Welding Society;

FIG. 8 schematically depicts a method according to an exemplary embodiment;

FIG. 9 is a photograph of a weld according to an exemplary embodiment;

FIG. 10 is a photograph of a longitudinal cross-section of a weld according to an exemplary embodiment;

FIG. 11A schematically depicts a joint for a method according to an exemplary embodiment;

and FIG. 11B schematically depicts a joint for a method according to an exemplary embodiment;

FIG. 12 shows a graph of tensile stress as a function of displacement of tension test specimens of a first metal;

FIG. 13 shows a graph of tensile stress as a function of displacement of tension test specimens of a second metal;

FIG. 14 shows a graph of tensile stress as a function of displacement of tension test specimens of a weld according to an exemplary embodiment of the first metal of FIG. 12 and the second metal of FIG. 13;

FIG. 15 shows photographs of the tension test specimens of the first metal of FIG. 12, after testing;

FIG. 16 shows photographs of the tension test specimens of the second metal of FIG. 13, after testing;

FIG. 17 shows photographs of the tension test specimens of the welded first metal and second metal of FIG. 14, after testing; and

FIG. 18 schematically depicts a joint for a method according to an exemplary embodiment.

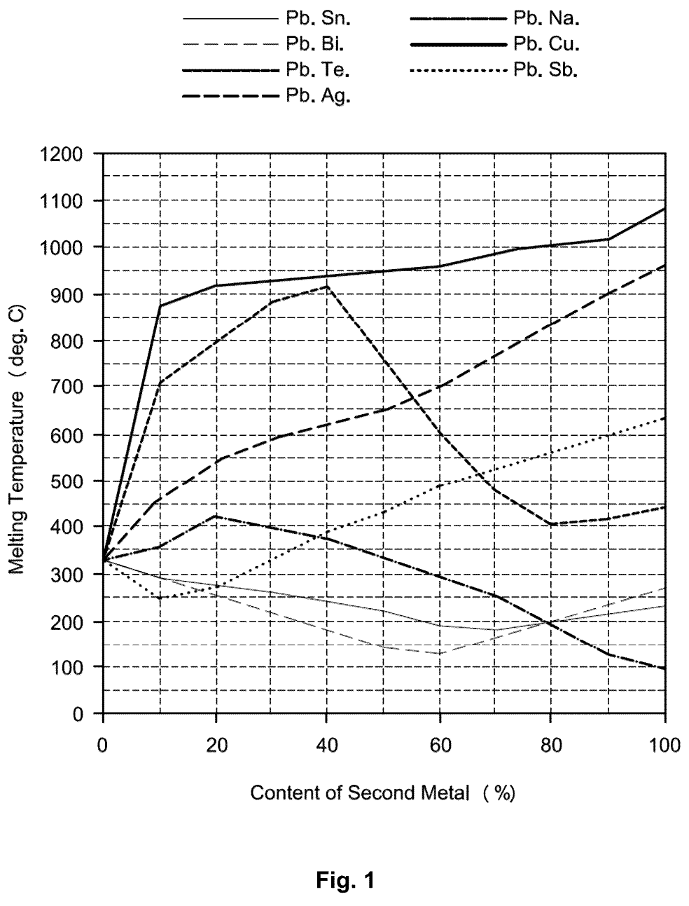

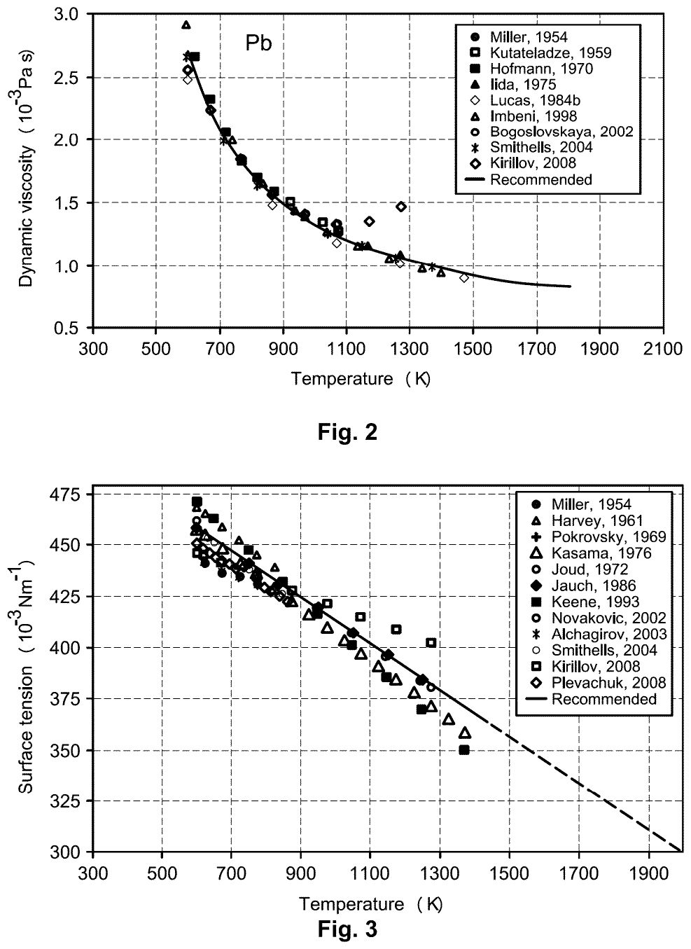

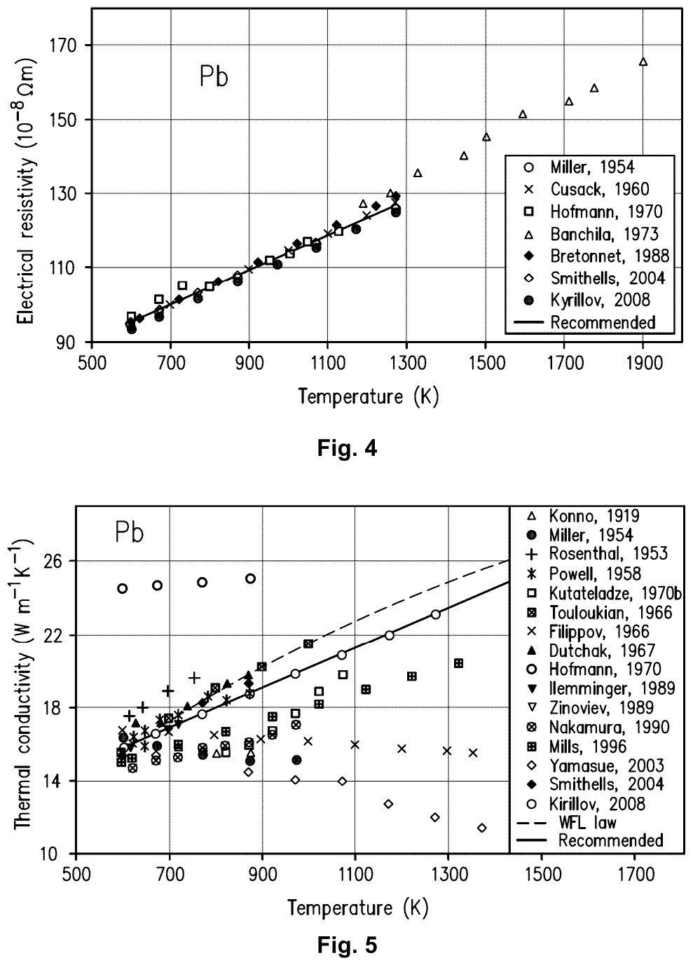

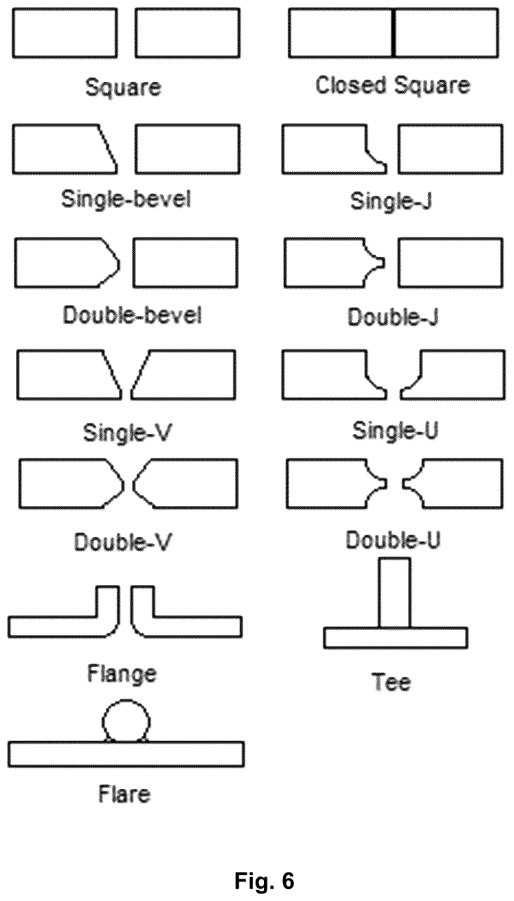

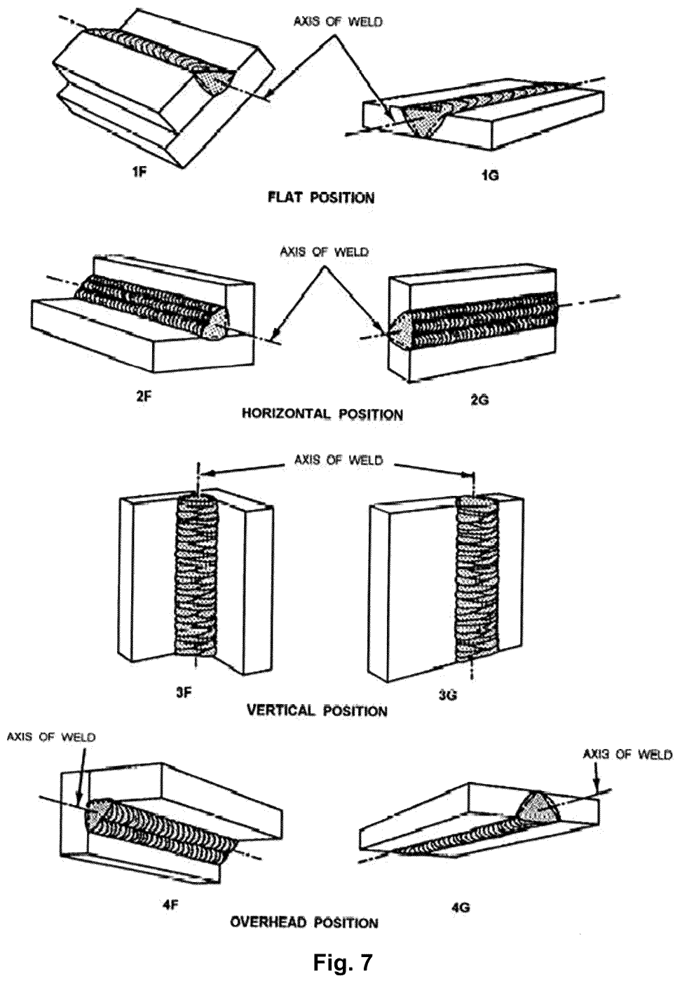

### DETAILED DESCRIPTION OF THE DRAWINGS

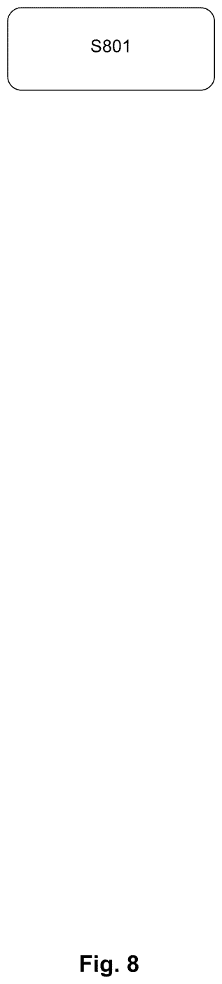

FIG. 8 schematically depicts a method according to an exemplary embodiment.

Particularly, the method is of joining a first metal and a second metal, wherein the first metal comprises Pb in an amount of at least 50 wt. % by weight of the first metal.

At S801, the first metal and the second metal are fused using non-consumable electrode arc welding.

### Experimental

### GTAW-DC Welding

GTAW welding was performed using a TWECO® ARCMASTER® 301TS using Stainshield TIG (Example E1) or Pureshield Argon (Example E2) at a flow rate of 10 litres/minute, for welding of an anode blade lead alloy, having a composition of Pb-1.5 wt. % Sn-0.08 wt. % Ca. That is, the first metal and the second metal have a composition of Pb-1.5 wt. % Sn-0.08 wt. % Ca and are plates, having a thickness of 6 mm. Closed square butt joints between the first metal and the second metal were prepared and the prepared joints were fused autogenously, by welding from both sides (i.e. double welded, closed butt joints) in a 1G position according to the parameters of Tables 11 to 12, at a speed of 30 mm s⁻¹. Default parameters were used otherwise. Metals having different thicknesses may be welded at corresponding welding currents and/or speeds. For example, relatively thicker metals may be welded at relatively higher welding currents and/or relatively lower welding speeds, while relatively similar metals may be welded at relatively lower welding currents and/or relatively higher welding speeds, for example scaled such as linearly according to thickness. The water-cooled torch was held and moved using a first industrial robot (i.e. automated).

TABLE 11
TWECO ARCMASTER 301TS parameters.

| | | Value | Value |
|---|---|---|---|
| Parameter | Description | E1 | E2 |
| Shielding | This parameter operates in GTAW modes only | 0.2 s | 0.5 s |
| gas pre-flow | and is used to provide gas to the weld zone | | |
| time | prior to striking the arc, once the torch trigger | | |
| | switch has been pressed. This control is used | | |
| | to reduce weld porosity at the start of a weld. | | |
| Start current | This parameter operates in GTAW modes only | 100 A (67%) | 5 A (1%) |
| AS | and is used to set the start current for TIG. | | |
| | In 4T mode the Initial Current remains on until | | |
| | the torch trigger switch is released after it has | | |
| | been depressed. In 2T mode the Initial Current | | |
| | remains on for the Start Current Time tS and | | |
| | then the Up Slope current ramp will | | |
| | commence. | | |
| Start Current | This parameter operates in 2T GTAW modes | 0.5 s | 0 s |
| Time tS | only and set the time the Start Current is | | |
| | active, after which the Up Slope current ramp | | |
| | will commence. | | |
| Up Slope | This parameter operates in GTAW modes only | 0.3 s | 0 s |
| Time | and is used to set the time for the weld current | | |
| | to ramp up from Initial current to welding | | |
| | current. | | |
| Welding | | 150 A | 190 A |
| Current A1 | | | |
| (AP) | | | |
| Trough | This parameter operates in GTAW Pulse | 99 A (66%) | 95 A (50%) |
| Current A2 | modes only and sets the GTAW TROUGH | | |
| (AB) | current. The lowest point in the pulse is called | | |
| | the Trough. | | |
| Down Slope | This parameter operates in GTAW modes only | 1.2 s (5%) | 0 s |
| Time | and is used to set the time for the weld current | | |
| | to ramp down to the crater current. This control | | |
| | is used to eliminate the crater that can form at | | |
| | the completion of a weld. | | |
| Crater | This parameter operates in GTAW modes | 21 A (14%) | 5 A (1%) |
| Current AE | only. This is the current at the end of the down | | |
| | slope current ramp. The welding current will | | |
| | remain at the Crater Current value until the | | |
| | Crater Current Time has elapsed, at which | | |
| | time the welding current will cease and the unit | | |
| | will enter Post Flow mode. This control is | | |
| | used to eliminate the crater that can form at | | |
| | the completion of a weld. | | |
| Crater | This parameter operates in GTAW modes only | 1.8 s | 0 s |
| Current Time | and is used to set the time for the crater | | |
| tE | current before entering post flow mode. This | | |
| | control is used to eliminate the crater that can | | |
| | form at the completion of a weld. | | |
| Shielding | This parameter operates in GTAW modes only | 26% | 60% |
| Gas Post- | and is used to adjust the post gas flow time | | |
| Flow time | once the arc has extinguished. This control is | | |
| | used to reduce oxidation of the tungsten | | |
| | electrode. | | |
| AC balance | This parameter operates in AC GTAW modes | | |
| | and is used to set the penetration to cleaning | | |
| | action ratio for the AC weld current. | | |
| Electrode | 1.5 to 5.0 mm | 2.4 mm | 2.4 mm |
| Diameter | | | |
| Pulse | This parameter sets the Pulse Frequency | 4 Hz | 125 Hz |
| Frequency | when in GTAW Pulse operating mode. | | |
| Pulse Duty | This parameter sets the percentage ″on″ time | 40% | 50% |
| Factor | of the Pulse Frequency for welding weld | | |
| | current when in Pulse operating mode | | |

TABLE 12
Electrode parameters.

| Parameter | Value |
|---|---|
| Diameter | 2.4 mm |
| Diameter at tip | 1.1 mm |
| Included angle | 45° |
| Taper length | 2.5 × diameter |
| Tip geometry | Pointed |
| Type | 2.0% thoriated |

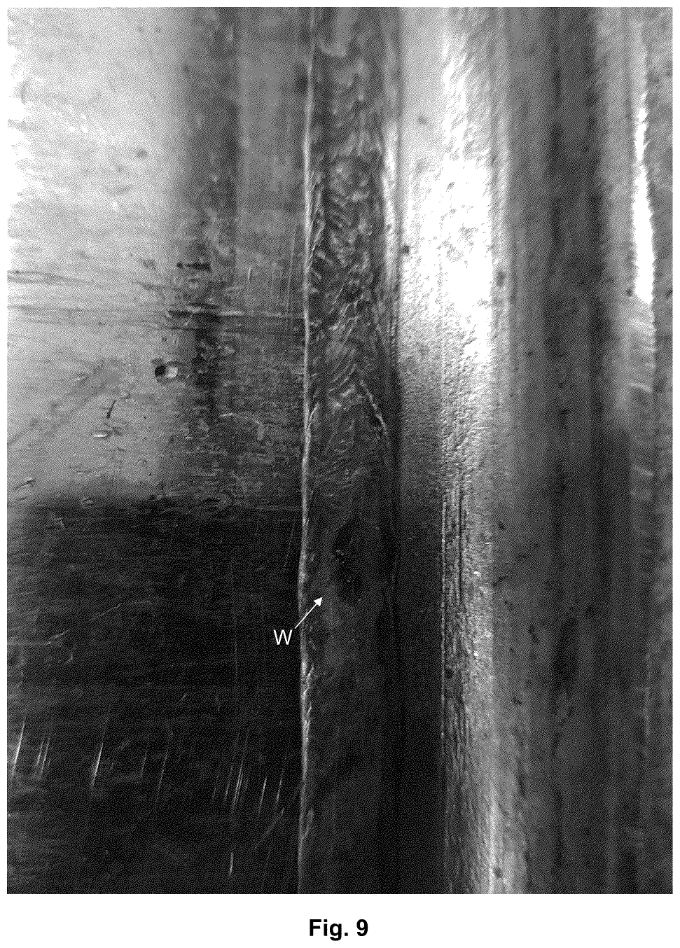

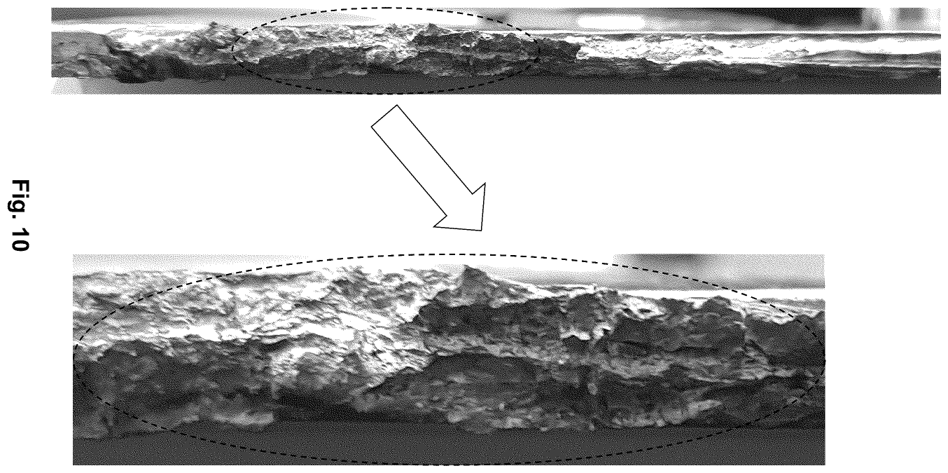

FIG. 9 is photograph of a weld according to an exemplary embodiment. Particularly, FIG. 9 is a photograph of a plan view of the weld W of example E2. The weld profile is visually acceptable, showing no undercut, no concavity and without excess convexity (at most 1 mm proud of the adjacent metal).

FIG. 10 shows a photograph of a longitudinal cross-section of a weld according to an exemplary embodiment. Particularly, FIG. 10 shows a photograph of the longitudinal cross-section of the weld of example E1, fractured longitudinally, after welding and cooling. Full fusion of the double welded, closed butt joint was achieved, due to sufficient penetration. Rather than fracturing longitudinally through the weld, fracture tends to occur adjacent to the weld, indicating that the welded metal is stronger than the unwelded metal.

### GTAW-DC and AC Welding

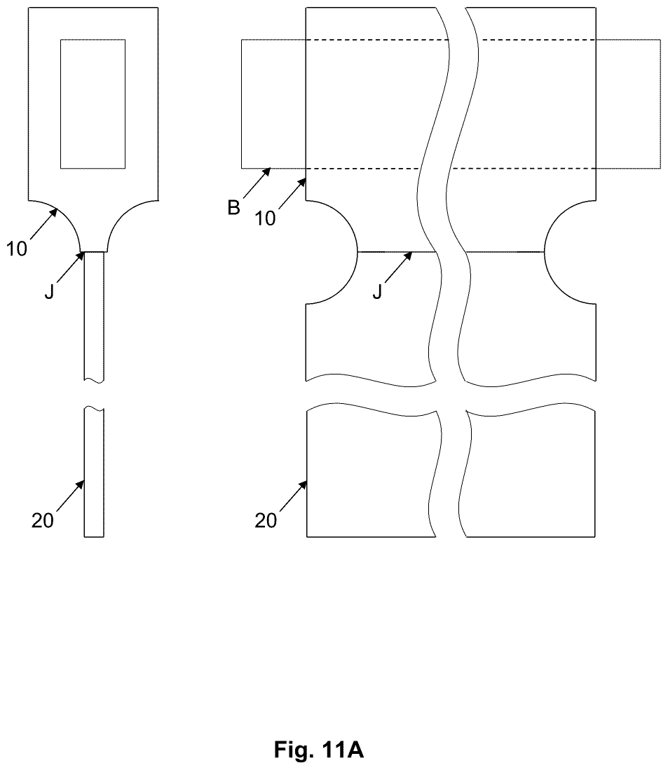

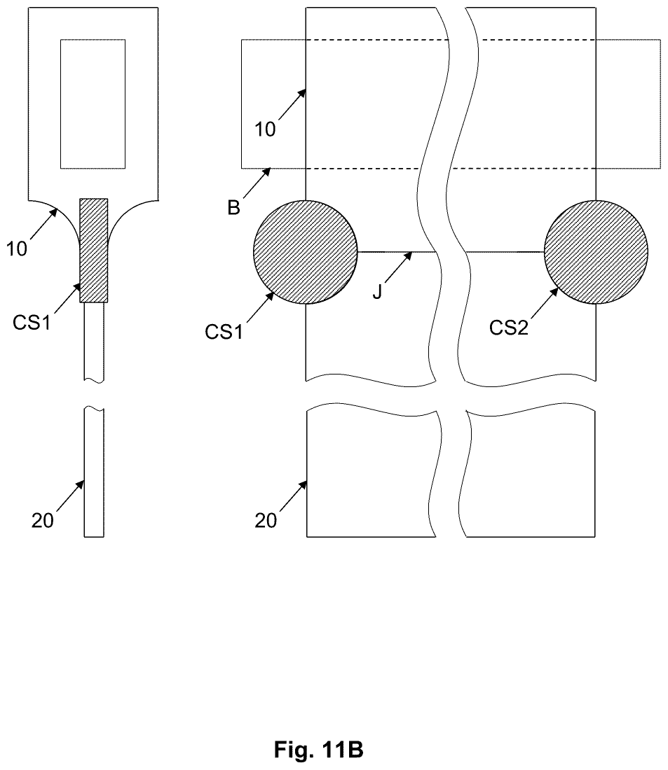

FIG. 11A schematically depicts a joint J for a method according to an exemplary embodiment. Particularly, FIG. 11A shows a plan elevation view and a corresponding end elevation view of the joint, having a length of about 1 m.

GTAW DC and AC welding was performed using a TWECO® ARCMASTER™ 301TS, for welding of an anode blade lead alloy 10 (i.e. a first metal), to a lead alloy coated anode bar, comprising a copper bar B having the lead alloy 20 (i.e. a second metal) coated thereon. The first metal 10 has a composition of Pb-1.5 wt. % Sn-0.08 wt. % Ca (referred to as calcium-tin alloy or TC) and a thickness of 6 mm. The second metal 20 has a composition of Pb-5.0 wt. % Sb (referred to as antimonial alloy or 5% ANT) and a thickness of 8 mm at the joint. During welding, some metal tends to flow from the relatively thicker second metal, thereby avoiding use of additional filler, for example. Closed (maximum 0.5 mm gap) square butt joints J between the first metal 10 and the second metal 20 were prepared by machining and the prepared joints J were fused autogenously, by welding from both sides (i.e. double welded, closed butt joints) in a 1G position according to the parameters of Tables 13A to 13C, the parameters having the meanings generally according to Tables 11 and 12 and as described previously. Unless specified otherwise, default parameters were used. Table 13 C summarises results for the welding. No flux was used. Metals having different thicknesses may be welded at corresponding welding currents and/or speeds. For example, relatively thicker metals may be welded at relatively higher welding currents and/or relatively lower welding speeds, while relatively similar metals may be welded at relatively lower welding currents and/or relatively higher welding speeds, for example scaled such as linearly according to thickness. Examples (i.e. TEST PLATE REF) 58-T1, 58-T2 and 58-T3 are for GTAW DC welding of double welded, closed butt joints between two plates of the first metal. The torch was held and moved using a first industrial robot (i.e. automated). Throughput was 15 to 20 such double welded 1 m long welds per hour, with manual set up of joints. Fully automating the welding, using industrial robots, will increase throughput to about 30 to 40 such double welded 1 m long welds per hour. This compares with 3 to 4 such double welded 1 m long welds per hour by manual lead burning by experienced welders. Semi-circular notches are provided at the start end and the stop end of the joint J, to reduce corrosion of the weld, in use. FIG. 11B schematically depicts a joint J for a method according to an exemplary embodiment, generally as described with respect to FIG. 11A, and including cold stops CS1, CS2 provided in contact with the start end and the stop end of the joint J, respectively. In this example, the cold stops CS1, CS2 are earthed discs of copper.

TABLE 13A
Parameters for welding of joints J.

| | | AC | START | | DOWN | SHIELDING | |
|---|---|---|---|---|---|---|---|
| TEST | PULSE | BALANCE/ | CURRENT | WELDING | SLOPE | GAS | |
| PLATE | FREQUENCY | AC | AS RAMP | CURRENT A1 | TIME | PRE-FLOW | SPEED |
| REF | (Hz) | FREQUENCY | UP (A) | (A) | (s) | TIME (s) | (mm s⁻¹) |
| 3107-T1 | 400 | | 69 | 150 | 0 | 0.5 | 28 |
| 317-T2 | 400 | | 60 | 140 | 0 | 0.5 | 28 |
| 317-T3 | 400 | | 50 | 130 | 0 | 0.5 | 28 |
| 317-T4 | 400 | | 69 | 150 | 0 | 0.5 | 28 |
| 317-T5 | 400 | | 80 | 160 | 0 | 0.5 | 28 |
| 317-T6 | 400 | | 75 | 155 | 0 | 0.5 | 28 |
| 18-T1 | 400 | | 69 | 150 | 0 | 0.5 | 28 |
| 18-T2 | 400 | | 60 | 140 | 0 | 0.5 | 28 |
| 18-T3 | 400 | | 50 | 130 | 0 | 0.5 | 28 |
| 18-T4 | 380 | | 69 | 150 | 0 | 0.5 | 25 |
| 18-T5 | 380 | | 80 | 160 | 0 | 0.5 | 25 |
| 18-T6 | 380 | | 75 | 155 | 0 | 0.5 | 25 |
| 18-T7 | 380 | | 69 | 150 | 0 | 0.5 | 28 |
| 18-T8 | 350 | | 60 | 140 | 0 | 0.5 | 28 |
| 18-T9 | 400 | | 69 | 130 | 0 | 0.5 | 28 |
| 18-T10 | 420 | | 69 | 150 | 0 | 0.5 | 28 |
| 18-T11 | 400 | | 80 | 160 | 0 | 0.5 | 28 |
| 18T12 | 400 | | 75 | 155 | 0 | 0.5 | 28 |
| 28-T1 | 400 | | 69 | 150 | 0 | 0.5 | 28 |
| 28-T2 | 400 | | 69 | 150 | 0 | 0.5 | 25 |
| 28-T3 | 400 | | 69 | 140 | 0 | 0.5 | 22 |
| 28-T4 | 400 | | 69 | 150 | 0 | 0.5 | 28 |
| 58-T1 | 400 | | 69 | 140 | 0 | 0.5 | 28 |
| 58-T2 | 400 | | 89 | 120 | 0 | 0.5 | 28 |
| 58-T3 | 400 | | 89 | 140 | 0 | 0.5 | 25 |
| 68-T1 | 0 | 10 | 89 | 140 | 0 | 0.5 | 28 |
| 68-T2 | 0 | 10 | 89 | 140 | 0 | 0.5 | 25 |
| 68-T3 | 0 | 10 | 89 | 130 | 0 | 0.5 | 25 |
| 68-T4 | 0 | 10 | 89 | 130 | 0 | 0.5 | 25 |
| 68-T5 | 0 | 10 | 89 | 120 | 0 | 0.5 | 25 |
| 68-T6 | 0 | 10 | 89 | 120 | 0 | 0.5 | 30 |
| 78-T1 | 0 | 20 | 120 | 140 | 0 | 0.5 | 25 |
| 78-T2 | 0 | 20 | 130 | 130 | 0 | 0.5 | 25 |
| 78-T3 | 0 | 20 | 120 | 120 | 0 | 0.5 | 25 |
| 78-T4 | 0 | 20 | 110 | 110 | 0 | 0.5 | 25 |
| 78-T5 | 0 | 20 | 100 | 100 | 0 | 0.5 | 25 |
| 78-T6 | 0 | 20 | 140 | 140 | 0 | 0.5 | 25 |
| 88-T1 | 0 | 20 | 120 | 140 | 0 | 0.5 | 20 |
| 88-T2 | 0 | 20 | 130 | 130 | 0 | 0.5 | 20 |
| 88-T3 | 0 | 20 | 120 | 120 | 0 | 0.5 | 15 |
| 88-T4 | 0 | 20 | 110 | 110 | 0 | 0.5 | 15 |
| 88-T5 | 0 | 20 | 100 | 100 | 0 | 0.5 | 15 |
| 88-T6 | 0 | 20 | 140 | 140 | 0 | 0.5 | 15 |
| 88-T7 | 0 | 20/40 | 120 | 140 | 0 | 0.5 | 20 |
| 88-T8 | 0 | 20/80 | 130 | 140 | 0 | 0.5 | 20 |
| 88-T9 | 0 | 20/30 | 120 | 140 | 0 | 0.5 | 20 |
| 88-T10 | 0 | 20/30 | 110 | 140 | 0 | 0.5 | 20 |
| 88-T11 | 0 | 20/30 | 100 | 140 | 0 | 0.5 | 20 |
| 88-T12 | 0 | 20/50 | 140 | 140 | 0 | 0.5 | 20 |
| 228-T1 | 0 | 20/40 | 120 | 130 | 0 | 0.5 | 25 |
| 228-T2 | 0 | 20/30 | 120 | 130 | 0 | 0.5 | 25 |
| 228-T3 | 0 | 20/30 | 120 | 130 | 0 | 0.5 | 25 |
| 228-T4 | 0 | 10/30 | 120 | 130 | 0 | 0.5 | 25 |
| 228-T5 | 0 | 30/40 | 120 | 140 | 0 | 0.5 | 25 |
| 228-T6 | 0 | 20/30 | 120 | 130 | 0 | 0.5 | 25 |
| 228-T7 | 0 | 10/30 | 120 | 130 | 0 | 0.5 | 25 |
| 228-T8 | 0 | 20/30 | 120 | 130 | 0 | 0.5 | 25 |
| 228-T9 | 0 | 30/30 | 120 | 120 | 0 | 0.5 | 25 |
| 228-T10 | 0 | 10/30 | 120 | 130 | 0 | 0.5 | 25 |
| 228-T11 | 0 | 10/40 | 120 | 140 | 0 | 0.5 | 25 |
| 228-T12 | 0 | 30/40 | 120 | 130 | 0 | 0.5 | 25 |
| 278-T1 | 0 | 20/40 | 120 | 130 | 0 | 0.5 | 25 |
| 278-T2 | 0 | 20/30 | 120 | 130 | 0 | 0.5 | 25 |
| 278-T3 | 0 | 20/30 | 120 | 130 | 0 | 0.5 | 28 |
| 278-T4 | 0 | 10/30 | 120 | 130 | 0 | 0.5 | 25 |
| 278-T5 | 0 | 30/30 | 120 | 140 | 0 | 0.5 | 25 |
| 278-T6 | 0 | 20/30 | 120 | 130 | 0 | 0.5 | 25 |
| 288-T7 | 0 | 10/30 | 120 | 130 | 0 | 0.5 | 25 |
| 228-T8 | 0 | 20/30 | 120 | 130 | 0 | 0.5 | 25 |
| 228-T9 | 0 | 30/30 | 120 | 120 | 0 | 0.5 | 25 |
| 228-T10 | 0 | 10/30 | 120 | 130 | 0 | 0.5 | 25 |
| 228-T11 | 0 | 10/40 | 120 | 130 | 0 | 0.5 | 25 |
| 228T12 | 0 | 30/30 | 120 | 130 | 0 | 0.5 | 25 |

TABLE 13B
Parameters for welding of joints J.

| | | ELECTRODE | | | SLOPE | | | |
|---|---|---|---|---|---|---|---|---|
| | | HEIGHT | | | RAMP | | SHIELDING | |
| TEST | | ABOVE | | | DOWN | | GAS POST- | |
| PLATE | START | SURFACE | GAS & FLOW | | TIME | NOZZLE | FLOW | |
| REF | POSITION | (MM) | (L MIN⁻¹) | ALIGNMENT | (s) | ANGLE | TIME (s) | ALLOYS |
| 3107-T1 | A | 2 MM | 5% HYD/ARG 15 L | LEVEL | 0.0 | 5 Deg | 3.9/61% | 5% ANT-TC |
| 317-T2 | A | 2 MM | 5% HYD/ARG 15 L | LEVEL | 0.0 | 5 Deg | 3.9/61% | 5% ANT-TC |
| 317-T3 | A | 2 MM | 5% HYD/ARG 15 L | LEVEL | 0.0 | 5 Deg | 3.9/61% | 5% ANT-TC |
| 317-T4 | A | 2 MM | 5% HYD/ARG 15 L | LEVEL | 0.0 | 5 Deg | 3.9/61% | 5% ANT-TC |
| 317-T5 | A | 2 MM | 5% HYD/ARG 15 L | LEVEL | 0.0 | 5 Deg | 3.9/61% | 5% ANT-TC |
| 317-T6 | A | 2 MM | 5% HYD/ARG 15 L | LEVEL | 0.0 | 5 Deg | 3.9/61% | 5% ANT-TC |
| 18-T1 | A | 2 MM | 5% HYD/ARG 15 L | LEVEL | 0.0 | 5 Deg | 3.9/61% | 5% ANT-TC |
| 18-T2 | A | 2 MM | 5% HYD/ARG 15 L | LEVEL | 0.0 | 5 Deg | 3.9/61% | 5% ANT-TC |
| 18-T3 | A | 2 MM | 5% HYD/ARG 15 L | LEVEL | 0.0 | 5 Deg | 3.9/61% | 5% ANT-TC |
| 18-T4 | A | 2 MM | 5% HYD/ARG 15 L | LEVEL | 0.0 | 5 Deg | 3.9/61% | 5% ANT-TC |
| 18-T5 | A | 2 MM | 5% HYD/ARG 15 L | LEVEL | 0.0 | 5 Deg | 3.9/61% | 5% ANT-TC |
| 18-T6 | A | 2 MM | 5% HYD/ARG 15 L | LEVEL | 0.0 | 5 Deg | 3.9/61% | 5% ANT-TC |
| 18-T7 | A | 2 MM | 5% HYD/ARG 15 L | LEVEL | 0.0 | 5 Deg | 3.9/61% | 5% ANT-TC |
| 18-T8 | A | 2 MM | 5% HYD/ARG 15 L | LEVEL | 0.0 | 5 Deg | 3.9/61% | 5% ANT-TC |
| 18-T9 | A | 2 MM | 5% HYD/ARG 15 L | LEVEL | 0.0 | 5 Deg | 3.9/61% | 5% ANT-TC |
| 18-T10 | A | 2 MM | 5% HYD/ARG 15 L | LEVEL | 0.0 | 5 Deg | 3.9/61% | 5% ANT-TC |
| 18-T11 | A | 2 MM | 5% HYD/ARG 15 L | LEVEL | 0.0 | 5 Deg | 3.9/61% | 5% ANT-TC |
| 18T12 | A | 2 MM | 5% HYD/ARG 15 L | LEVEL | 0.0 | 5 Deg | 3.9/61% | 5% ANT-TC |
| 28-T1 | A | 2 MM | 5% HYD/ARG 15 L | UNEVEN | 0.0 | 5 Deg | 3.9/61% | 5% ANT-TC |
| 28-T2 | A | 2 MM | 5% HYD/ARG 15 L | UNEVEN | 0.0 | 5 Deg | 3.9/61% | 5% ANT-TC |
| 28-T3 | A | 2 MM | 5% HYD/ARG 15 L | UNEVEN | 0.0 | 5 Deg | 3.9/61% | 5% ANT-TC |
| 28-T4 | B | 2 MM | 5% HYD/ARG 15 L | UNEVEN | 0.0 | 5 Deg | 3.9/61% | 5% ANT-TC |
| 58-T1 | A | 2 MM | 5% HYD/ARG 15 L | LEVEL | 0.0 | 5 Deg | 3.9/61% | TC-TC |
| 58-T2 | A | 2 MM | 5% HYD/ARG 15 L | LEVEL | 0.0 | 5 Deg | 3.9/61% | TC-TC |
| 58-T3 | A | 2 MM | 5% HYD/ARG 15 L | LEVEL | 0.0 | 5 Deg | 3.9/61% | TC-TC |
| 68-T1 | A | 2 MM | PURE ARGON 15 L | LEVEL | 0.0 | VERTICAL | 3.9/61% | 5% ANT-TC |
| 68-T2 | A | 2 MM | PURE ARGON 15 L | LEVEL | 0.0 | VERTICAL | 3.9/61% | 5% ANT-TC |
| 68-T3 | A | 2 MM | PURE ARGON 15 L | LEVEL | 0.0 | VERTICAL | 3.9/61% | 5% ANT-TC |
| 68-T4 | A | 2 MM | PURE ARGON 15 L | LEVEL | 0.0 | VERTICAL | 3.9/61% | 5% ANT-TC |
| 68-T5 | A | 2 MM | PURE ARGON 15 L | LEVEL | 0.0 | VERTICAL | 3.9/61% | 5% ANT-TC |
| 68-T6 | A | 2 MM | PURE ARGON 15 L | LEVEL | 0.0 | VERTICAL | 3.9/61% | 5% ANT-TC |
| 78-T1 | A | 2 MM | 5% HYD/ARG 15 L | LEVEL | 0.0 | VERTICAL | 3.9/61% | 5% ANT-TC |
| 78-T2 | A | 2 MM | 5% HYD/ARG 15 L | LEVEL | 0.0 | VERTICAL | 3.9/61% | 5% ANT-TC |
| 78-T3 | A | 2 MM | 5% HYD/ARG 15 L | LEVEL | 0.0 | VERTICAL | 3.9/61% | 5% ANT-TC |
| 78-T4 | A | 2 MM | 5% HYD/ARG 15 L | LEVEL | 0.0 | VERTICAL | 3.9/61% | 5% ANT-TC |
| 78-T5 | A | 2 MM | 5% HYD/ARG 15 L | LEVEL | 0.0 | VERTICAL | 3.9/61% | 5% ANT-TC |
| 78-T6 | A | 2 MM | 5% HYD/ARG 15 L | LEVEL | 0.0 | VERTICAL | 3.9/61% | 5% ANT-TC |
| 88-T1 | A | 2 MM | 5% HYD/ARG 15 L | UNEVEN | 0.0 | VERTICAL | 3.9/61% | 5% ANT-TC |
| 88-T2 | A | 2 MM | 5% HYD/ARG 15 L | UNEVEN | 0.0 | VERTICAL | 3.9/61% | 5% ANT-TC |
| 88-T3 | A | 2 MM | 5% HYD/ARG 15 L | UNEVEN | 0.0 | VERTICAL | 3.9/61% | 5% ANT-TC |
| 88-T4 | A | 2 MM | 5% HYD/ARG 15 L | UNEVEN | 0.0 | VERTICAL | 3.9/61% | 5% ANT-TC |
| 88-T5 | A | 2 MM | 5% HYD/ARG 15 L | UNEVEN | 0.0 | VERTICAL | 3.9/61% | 5% ANT-TC |
| 88-T6 | A | 2 MM | 5% HYD/ARG 15 L | UNEVEN | 0.0 | VERTICAL | 3.9/61% | 5% ANT-TC |
| 88-T7 | A | 2 MM | 5% HYD/ARG 15 L | LEVEL | 0.0 | VERTICAL | 3.9/61% | 5% ANT-TC |
| 88-T8 | A | 2 MM | 5% HYD/ARG 15 L | LEVEL | 0.0 | VERTICAL | 3.9/61% | 5% ANT-TC |
| 88-T9 | A | 2 MM | 5% HYD/ARG 15 L | LEVEL | 0.0 | VERTICAL | 3.9/61% | 5% ANT-TC |
| 88-T10 | A | 2 MM | 5% HYD/ARG 15 L | LEVEL | 0.0 | VERTICAL | 3.9/61% | 5% ANT-TC |
| 88-T11 | A | 2 MM | 5% HYD/ARG 15 L | LEVEL | 0.0 | VERTICAL | 3.9/61% | 5% ANT-TC |
| 88-T12 | A | 2 MM | 5% HYD/ARG 15 L | LEVEL | 0.0 | VERTICAL | 3.9/61% | 5% ANT-TC |
| 228-T1 | A | 2 MM | 5% HYD/ARG 15 L | LEVEL | 0.0 | VERTICAL | 3.9/61% | 5% ANT-TC |
| 228-T2 | A | 2 MM | 5% HYD/ARG 15 L | LEVEL | 0.0 | VERTICAL | 3.9/61% | 5% ANT-TC |
| 228-T3 | A | 2 MM | 5% HYD/ARG 15 L | LEVEL | 0.0 | VERTICAL | 3.9/61% | 5% ANT-TC |
| 228-T4 | A | 2 MM | 5% HYD/ARG 15 L | LEVEL | 0.0 | VERTICAL | 3.9/61% | 5% ANT-TC |
| 228-T5 | A | 2 MM | 5% HYD/ARG 15 L | LEVEL | 0.0 | VERTICAL | 3.9/61% | 5% ANT-TC |
| 228-T6 | A | 2 MM | 5% HYD/ARG 15 L | LEVEL | 0.0 | VERTICAL | 3.9/61% | 5% ANT-TC |
| 228-T7 | A | 2 MM | 5% HYD/ARG 15 L | LEVEL | 0.0 | VERTICAL | 3.9/61% | 5% ANT-TC |
| 228-T8 | A | 2 MM | 5% HYD/ARG 15 L | LEVEL | 0.0 | VERTICAL | 3.9/61% | 5% ANT-TC |
| 228-T9 | A | 2 MM | 5% HYD/ARG 15 L | LEVEL | 0.0 | VERTICAL | 3.9/61% | 5% ANT-TC |
| 228-T10 | A | 2 MM | 5% HYD/ARG 15 L | LEVEL | 0.0 | VERTICAL | 3.9/61% | 5% ANT-TC |
| 228-T11 | A | 2 MM | 5% HYD/ARG 15 L | LEVEL | 0.0 | VERTICAL | 3.9/61% | 5% ANT-TC |
| 228-T12 | A | 2 MM | 5% HYD/ARG 15 L | LEVEL | 0.0 | VERTICAL | 3.9/61% | 5% ANT-TC |
| 278-T1 | A | 2 MM | 5% HYD/ARG 15 L | LEVEL | 0.0 | VERTICAL | 3.9/61% | 5% ANT-TC |
| 278-T2 | A | 2 MM | 5% HYD/ARG 15 L | LEVEL | 0.0 | VERTICAL | 3.9/61% | 5% ANT-TC |
| 278-T3 | A | 2 MM | 5% HYD/ARG 15 L | LEVEL | 0.0 | VERTICAL | 3.9/61% | 5% ANT-TC |
| 278-T4 | A | 2 MM | 5% HYD/ARG 15 L | LEVEL | 0.0 | VERTICAL | 3.9/61% | 5% ANT-TC |
| 278-T5 | A | 2 MM | 5% HYD/ARG 15 L | LEVEL | 0.0 | VERTICAL | 3.9/61% | 5% ANT-TC |
| 278-T6 | A | 2 MM | 5% HYD/ARG 15 L | LEVEL | 0.0 | VERTICAL | 3.9/61% | 5% ANT-TC |
| 288-T7 | A | 2 MM | 5% HYD/ARG 15 L | LEVEL | 0.0 | VERTICAL | 3.9/61% | 5% ANT-TC |
| 228-T8 | A | 2 MM | 5% HYD/ARG 15 L | LEVEL | 0.0 | VERTICAL | 3.9/61% | 5% ANT-TC |
| 228-T9 | A | 2 MM | 5% HYD/ARG 15 L | LEVEL | 0.0 | VERTICAL | 3.9/61% | 5% ANT-TC |
| 228-T10 | A | 2 MM | 5% HYD/ARG 15 L | LEVEL | 0.0 | VERTICAL | 3.9/61% | 5% ANT-TC |
| 228-T11 | A | 2 MM | 5% HYD/ARG 15 L | LEVEL | 0.0 | VERTICAL | 3.9/61% | 5% ANT-TC |
| 228-T12 | A | 2 MM | 5% HYD/ARG 15 L | LEVEL | 0.0 | VERTICAL | 3.9/61% | 5% ANT-TC |

TABLE 13C
Results for welding of joints J.

| TEST | | | | | FINISH | | TENSILE | |
|---|---|---|---|---|---|---|---|---|
| PLATE | GENERAL | FLAWS & | FULL LENGTH | | POSITION | NDT | TEST | RESULTS/ |
| REF | APPEARANCE | INCLUSIONS | CONSISTENCY | CLEANLINESS | DETAIL | RESULT | RESULT | COMMENTS |
| 3107- | POOR | YES | POOR | OK | LONG | N/A | N/A | Weld uneven |
| T1 | | | | | CRATER | | | |
| 317- | POOR | YES | POOR | OK | LONG | N/A | N/A | Weld uneven |
| T2 | | | | | CRATER | | | |
| 317- | POOR | YES | POOR | OK | LONG | N/A | N/A | Weld uneven |
| T3 | | | | | CRATER | | | |
| 317- | POOR | YES | POOR | OK | LONG | N/A | N/A | Weld uneven |
| T4 | | | | | CRATER | | | |
| 317- | POOR | YES | POOR | OK | LONG | N/A | N/A | Weld uneven |
| T5 | | | | | CRATER | | | |
| 317- | POOR | YES | POOR | OK | LONG | N/A | N/A | Weld uneven |
| T6 | | | | | CRATER | | | |
| 18-T1 | FAILED | YES | POOR | OK | LONG | N/A | N/A | Weld uneven |
| | | | | | CRATER | | | |
| 18-T2 | PART OK | YES | POOR | OK | LONG | N/A | N/A | Weld uneven |
| | | | | | CRATER | | | |
| 18-T3 | FLAWS | YES | POOR | OK | LONG | N/A | N/A | Weld uneven |
| | | | | | CRATER | | | |
| 18-T4 | FLAWS | YES | POOR | OK | LONG | N/A | N/A | Weld uneven |
| | | | | | CRATER | | | |
| 18-T5 | POROSITY | YES | POOR | OK | LONG | N/A | N/A | Weld uneven |
| | | | | | CRATER | | | |
| 18-T6 | FAILED | YES | POOR | OK | LONG | N/A | N/A | Weld uneven |
| | | | | | CRATER | | | |
| 18-T7 | POOR | YES | BETTER | OK | LONG | N/A | N/A | Weld Flatter |
| | | | | | CRATER | | | |
| 18-T8 | POOR | YES | BETTER | OK | LONG | N/A | N/A | Weld Flatter |
| | | | | | CRATER | | | |
| 18-T9 | POOR | YES | BETTER | OK | LONG | N/A | N/A | Weld Flatter |
| | | | | | CRATER | | | |
| 18- | POOR | YES | BETTER | OK | LONG | N/A | N/A | Weld Flatter |
| T10 | | | | | CRATER | | | |
| 18- | POOR | YES | BETTER | OK | LONG | N/A | N/A | Weld Flatter |
| T11 | | | | | CRATER | | | |
| 18T12 | POOR | YES | BETTER | OK | LONG | N/A | N/A | Weld Flatter |
| | | | | | CRATER | | | |
| 28-T1 | POOR | YES | POOR | POOR | LONG | N/A | N/A | Weld uneven |
| | | | | | CRATER | | | |
| 28-T2 | SOOTY | YES | POOR | POOR | LONG | Bend | N/A | Weld uneven |
| | | | | | CRATER | tested | | |
| 28-T3 | FLAWS | YES | POOR | POOR | LONG | N/A | N/A | Weld uneven |
| | | | | | CRATER | | | |
| 28-T4 | POOR | YES | POOR | POOR | LONG | N/A | N/A | Weld uneven |
| | | | | | CRATER | | | |
| 58-T1 | GOOD | SOME | BETTER | OK | LONG | N/A | N/A | Weld uneven |
| | | | | | CRATER | | | |
| 58-T2 | GOOD | SOME | BETTER | OK | LONG | N/A | N/A | Weld uneven |
| | | | | | CRATER | | | |
| 58-T3 | GOOD | SOME | BETTER | OK | LONG | N/A | N/A | Weld uneven |
| | | | | | CRATER | | | |
| 68-T1 | MUCH | LITTLE | BETTER | QUITE | LESS | N/A | N/A | Weld flatter |
| | BETTER | | | SOOTY | CRATER | | | |
| 68-T2 | MUCH | LITTLE | BETTER | QUITE | LESS | N/A | N/A | Weld flatter |
| | BETTER | | | SOOTY | CRATER | | | |
| 68-T3 | MUCH | LITTLE | BETTER | QUITE | LESS | N/A | N/A | Weld flatter |
| | BETTER | | | SOOTY | CRATER | | | |
| 68-T4 | MUCH | LITTLE | BETTER | QUITE | LESS | N/A | N/A | Weld flatter |
| | BETTER | | | SOOTY | CRATER | | | |
| 68-T5 | MUCH | LITTLE | BETTER | QUITE | LESS | N/A | N/A | Weld flatter |
| | BETTER | | | SOOTY | CRATER | | | |
| 68-T6 | MUCH | LITTLE | BETTER | QUITE | LESS | N/A | N/A | Weld flatter |
| | BETTER | | | SOOTY | CRATER | | | |
| 78-T1 | MUCH | LITTLE | BETTER | VERY | LESS | N/A | N/A | Weld flatter |
| | BETTER | | | SOOTY | CRATER | | | |
| 78-T2 | MUCH | LITTLE | BETTER | VERY | LESS | N/A | N/A | Weld flatter |
| | BETTER | | | SOOTY | CRATER | | | |
| 78-T3 | MUCH | LITTLE | BETTER | VERY | LESS | N/A | N/A | Weld flatter |
| | BETTER | | | SOOTY | CRATER | | | |
| 78-T4 | MUCH | LITTLE | BETTER | VERY | LESS | N/A | N/A | Weld flatter |
| | BETTER | | | SOOTY | CRATER | | | |
| 78-T5 | MUCH | LITTLE | BETTER | VERY | LESS | N/A | N/A | Weld flatter |
| | BETTER | | | SOOTY | CRATER | | | |
| 78-T6 | MUCH | LITTLE | BETTER | VERY | LESS | N/A | N/A | Weld flatter |
| | BETTER | | | SOOTY | CRATER | | | |
| 88-T1 | BAD | BAD | BETTER | VERY | FAILED | N/A | N/A | FAILED |
| | | | | SOOTY | | | | |
| 88-T2 | BAD | BAD | BETTER | VERY | FAILED | N/A | N/A | FAILED |
| | | | | SOOTY | | | | |
| 88-T3 | BAD | BAD | FAILED | VERY | FAILED | FAILED | FAILED | FAILED |
| | | | | SOOTY | | | | |
| 88-T4 | BAD | BAD | FAILED | VERY | FAILED | FAILED | FAILED | FAILED |
| | | | | SOOTY | | | | |
| 88-T5 | BAD | BAD | FAILED | VERY | FAILED | FAILED | FAILED | FAILED |
| | | | | SOOTY | | | | |
| 88-T6 | BAD | BAD | FAILED | VERY | FAILED | FAILED | FAILED | FAILED |
| | | | | SOOTY | | | | |
| 88-T7 | GOOD | FEW | GOOD | VERY | GOOD | N/A | N/A | GOOD FLAT |
| | | FLAWS | | SOOTY | | | | WELD |
| 88-T8 | FAILED | FAILED | FAILED | FAILED | FAILED | FAILED | FAILED | FAILED |
| 88-T9 | GOOD | FEW | GOOD | VERY | GOOD | N/A | N/A | GOOD FLAT |
| | | FLAWS | | SOOTY | | | | WELD |
| 88- | GOOD | FEW | GOOD | VERY | GOOD | N/A | N/A | GOOD FLAT |
| T10 | | FLAWS | | SOOTY | | | | WELD |
| 88- | GOOD | FEW | GOOD | VERY | GOOD | N/A | N/A | GOOD FLAT |
| T11 | | FLAWS | | SOOTY | | | | WELD |
| 88- | GOOD | FEW | GOOD | VERY | GOOD | N/A | N/A | GOOD FLAT |
| T12 | | FLAWS | | SOOTY | | | | WELD |
| 228- | GOOD | GOOD | GOOD | VERY | GOOD | N/A | N/A | GOOD FLAT |
| T1 | | | | SOOTY | | | | WELD |
| 228- | GOOD | GOOD | GOOD | VERY | GOOD | N/A | N/A | GOOD FLAT |
| T2 | | | | SOOTY | | | | WELD |
| 228- | GOOD | GOOD | GOOD | VERY | GOOD | N/A | N/A | GOOD FLAT |
| T3 | | | | SOOTY | | | | WELD |
| 228- | GOOD | GOOD | GOOD | VERY | GOOD | N/A | N/A | GOOD FLAT |
| T4 | | | | SOOTY | | | | WELD |
| 228- | GOOD | GOOD | GOOD | VERY | GOOD | N/A | N/A | GOOD FLAT |
| T5 | | | | SOOTY | | | | WELD |
| 228- | GOOD | GOOD | GOOD | VERY | GOOD | N/A | N/A | GOOD FLAT |
| T6 | | | | SOOTY | | | | WELD |
| 228- | GOOD | GOOD | GOOD | VERY | GOOD | N/A | N/A | GOOD FLAT |
| T7 | | | | SOOTY | | | | WELD |
| 228- | GOOD | GOOD | GOOD | VERY | GOOD | N/A | N/A | GOOD FLAT |
| T8 | | | | SOOTY | | | | WELD |
| 228- | GOOD | GOOD | GOOD | VERY | GOOD | N/A | N/A | GOOD FLAT |
| T9 | | | | SOOTY | | | | WELD |
| 228- | GOOD | GOOD | GOOD | VERY | GOOD | N/A | N/A | GOOD FLAT |
| T10 | | | | SOOTY | | | | WELD |
| 228- | GOOD | GOOD | GOOD | VERY | GOOD | N/A | N/A | GOOD FLAT |
| T11 | | | | SOOTY | | | | WELD |
| 228- | GOOD | GOOD | GOOD | VERY | GOOD | N/A | N/A | GOOD FLAT |
| T12 | | | | SOOTY | | | | WELD |
| 278- | GOOD | GOOD | GOOD | VERY | GOOD | N/A | AT AMRC FOR | GOOD FLAT |
| T1 | | | | SOOTY | | | TEST | WELD |
| 278- | GOOD | GOOD | GOOD | VERY | GOOD | N/A | AT AMRC FOR | GOOD FLAT |
| T2 | | | | SOOTY | | | TEST | WELD |
| 278- | GOOD | GOOD | GOOD | VERY | GOOD | N/A | AT AMRC FOR | GOOD FLAT |
| T3 | | | | SOOTY | | | TEST | WELD |
| 278- | GOOD | GOOD | GOOD | VERY | GOOD | N/A | AT AMRC FOR | GOOD FLAT |
| T4 | | | | SOOTY | | | TEST | WELD |
| 278- | GOOD | GOOD | GOOD | VERY | GOOD | N/A | AT AMRC FOR | GOOD FLAT |
| T5 | | | | SOOTY | | | TEST | WELD |
| 278- | GOOD | GOOD | GOOD | VERY | GOOD | N/A | AT AMRC FOR | GOOD FLAT |
| T6 | | | | SOOTY | | | TEST | WELD |
| 288- | GOOD | GOOD | GOOD | VERY | GOOD | N/A | AT AMRC FOR | GOOD FLAT |
| T7 | | | | SOOTY | | | TEST | WELD |
| 228- | GOOD | GOOD | GOOD | VERY | GOOD | N/A | AT AMRC FOR | GOOD FLAT |
| T8 | | | | SOOTY | | | TEST | WELD |
| 228- | GOOD | GOOD | GOOD | VERY | GOOD | N/A | AT AMRC FOR | GOOD FLAT |
| T9 | | | | SOOTY | | | TEST | WELD |
| 228- | GOOD | GOOD | GOOD | VERY | GOOD | N/A | AT AMRC FOR | GOOD FLAT |
| T10 | | | | SOOTY | | | TEST | WELD |
| 228- | GOOD | GOOD | GOOD | VERY | GOOD | N/A | WITHDRAWN | WITHDRAWN |
| T11 | | | | SOOTY | | | | |
| 228- | GOOD | GOOD | GOOD | VERY | GOOD | N/A | AT AMRC FOR | GOOD FLAT |
| T12 | | | | SOOTY | | | TEST | WELD |

Table 13C generally shows that for GTAW welding of the calcium-tin alloy to the antimonial alloy, using the systematically tested parameters shown in Table 13A to 13C, GTAW AC welding is generally preferred.

Particularly, Examples 3107-T1 to 28-T4 inclusive, for GTAW DC welding of the calcium-tin alloy to the antimonial alloy, generally have poor appearance and poor full-length consistency, while also having inclusions. Weld cleanliness, though, is generally OK.

In contrast, Examples 58-T1, 58-T2 and 58-T3, for GTAW DC welding of the calcium-tin alloy to the calcium-tin alloy, have good appearance and better full-length consistency, while also having only inclusions. Weld cleanliness is also OK. This is consistent with Example E1 and E2.

Examples 88-T7 to 228-T12 inclusive (except for Example 88-T8), for GTAW AC welding of the calcium-tin alloy to the antimonial alloy, generally have good appearance and good full-length consistency, while also no inclusions. Weld cleanliness, though, is generally very sooty but the sooty is surface only, not resulting in defects, and readily removed by wiping. The soot arises from aluminium present in the calcium-tin alloy and is not detrimental to weld properties. Rewelding of the weld, after removing the soot, produces a weld having excellent appearance.

Table 14 summarises acceptable parameter ranges for GTAW AC welding of the calcium-tin alloy to the antimonial alloy, based on Examples 88-T7 to 228-T12 inclusive (except for Example 88-T8).

TABLE 14
Acceptable parameter ranges for GTAW AC welding of the calcium-tin alloy to the
antimonial alloy. Preferred parameter values for the GTAW AC welding of the calcium-tin alloy
to the antimonial alloy, for example having the described geometry, in bold.

| Parameter | Range |
|---|---|
| AC balance | 10% to 50%, preferably 10% to 40%, more |
| | preferably 10% to 30%, for example 10%, |
| | 20% or 30%. 20% gives a good balance |
| | between cleanliness and penetration. |
| AC frequency (Hz) | 10 Hz to 70 Hz, preferably 20 Hz to 60 Hz, |
| | more preferably 30 Hz to 50 Hz, for example |
| | 30 Hz, 40 Hz or 50 Hz. 30 Hz is suitable for 6 |
| | mm plate and 40 Hz for 8 mm plate. |
| Start current AS (%) | 70% to 120%, preferably 80% to 110%, more |
| | preferably90% to 100%, for example 90%, |
| | 92.5%, 95%, 97.5% or 100% |
| Welding current A1 (A) | 100 A to 170 A, preferably 110 A to 160 A, |
| | more preferably 120 A to 150 A, for example |
| | 120 A, 130 A, 140 A or 150 A. 130 A is |
| | suitable for 6 mm plate and 140 A for 8 mm |
| | plate, giving penetration of at least 50%, |
| | particularly about 160%. Increasing the |
| | current results in burn through while |
| | decreasing the current results in insufficient |
| | penetration. |
| Ramp down (s) | 0 s. Burning through is avoided by limiting |
| | heat input at the weld stop. |
| Shielding gas pre-flow time (s) | 0 s to 2 s, preferably 0. 25 s to 1 s, for |
| | example 0.5 s |
| Speed (mm s⁻¹) | 10 mm s⁻¹ to 40 mm s⁻¹, preferably 15 mm s⁻¹ |
| | to 35 mm s⁻¹, more preferably 20 mm s⁻¹ to 30 |
| | mm s⁻¹, for example 20 mm s⁻¹, 25 mm s⁻¹, 28 |
| | mm s⁻¹or 30 mm s⁻¹ |
| Start position | A i.e. about 5 mm from the end of the joint |
| | thereby providing penetration to the end of |
| | the joint. Starting closer to the end of the joint |
| | may result in burn through while starting |
| | further from the end of the joint may result in |
| | insufficient penetration to the end of the joint. |
| Electrode height above surface (mm) | 1.0 mm to 6.0 mm, preferably 1.5 mm to 5.0 |
| | mm, more preferably 2.0 mm to 4.0 mm, most |
| | preferably 3.0 mm to 4.0 mm, for example |
| | 3.0 mm, 3.25 mm, 3.5 mm, 3.75 mm or 4.0 |
| | mm. Higher gas flows at lower heights may |
| | blow out the plasma. |
| Gas | Specshield 95% argon, 5% hydrogen. |
| Gas flow (L min⁻¹) | 2.5 L min⁻¹ to 25 L min⁻¹, preferably 5 L min⁻¹ |
| | to 20 L min⁻¹, more preferably 7.5 L min⁻¹ to |
| | 17.5 L min⁻¹, for example 10 L min−1. Higher |
| | gas flows at lower heights may blow out the |
| | plasma. |
| Alignment of the surfaces of the plates | Level or step e.g. 1 mm to 2 mm. The molten |
| | step flows into the weld, providing filler metal, |
| | if required |
| Down slope time (s) | 0 s to 2 s, preferably 0 s to 1 s, for example 0 |
| | s, 0.25 s, 0.5 s, 0.75 s or 1 s. Burning through |
| | is avoided by limiting heat input at the weld |
| | stop. |
| Nozzle Angle | Vertical or slightly trailing around 87 |
| | degrees. Improved weld appearance while |
| | allowing for monitoring during welding. |
| Shielding gas post-flow time (s) | 0.5 s to 10 s, preferably 1 to 8 s, more |
| | preferably 1 to 6 s, for example 1, 1.5, 2, 3, 4, |
| | 5 or 6 s. The weld metal solidifies rapidly such |
| | that lengthy shielding gas post-flow is not |
| | required. |

### Mechanical Testing

Examples 278-T1 to 228-T12 inclusive (except for Example 228-T11) were subject to mechanical testing, as described below.

Tension test specimens were prepared conforming with ASME IBPVC.IX-2015 (see QW-151). Three (3) batches of five (5) test specimens were prepared from:
a. Batch of six (6) of parent material antimonial alloy;
b. Batch of six (6) of parent material calcium-tin alloy; and
c. Batch of six (6) welded material of these two materials.

The tension test specimens were tested conforming with ASME IBPVC.IX-2015 (see QW-152). Photographs showing respective failure modes of the tension test specimens were obtained.

### Calcium-Tin Alloy Test Specimens

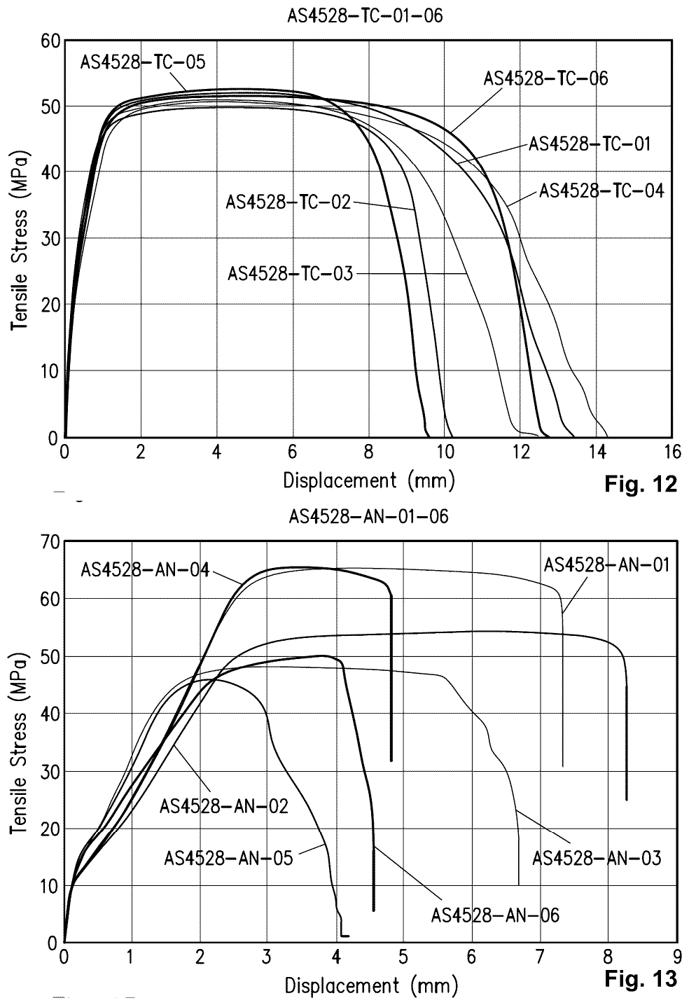

FIG. 12 shows a graph of tensile stress as a function of displacement for the calcium-tin alloy tension test specimens. Table 15 summarises dimensions and tension test results for the calcium-tin alloy tension test specimens. The mean ultimate tensile strength (UTS) was 48.1 MPa, having a standard deviation of 0.84 MPa. Elongation to failure was 18.3%, having a standard deviation of 4.6%.

TABLE 15
Dimensions and tension test results for calcium-tin alloy tension test specimens.

| | | | | | | | Original | Final | |
|---|---|---|---|---|---|---|---|---|---|
| Test | Overall | | | | | | Gauge | Gauge | |
| specimen | Length | Width | Thickness | CSA | Load | UTS | Length | Length | Elongation |
| No. | (mm) | (mm) | (mm) | (mm²) | (N) | (MPa) | (mm) | (mm) | (%) |
| AS4528 - TC - 01 | 201.58 | 12.57 | 6.28 | 79 | 3850 | 48.8 | 50.11 | 60.12 | 19.98 |
| AS4528 - TC - 02 | 201.21 | 12.60 | 6.23 | 78 | 3680 | 46.9 | 50.09 | 56.07 | 11.94 |
| AS4528 - TC - 03 | 200.45 | 12.47 | 6.24 | 78 | 3720 | 47.8 | 50.16 | 60.92 | 21.45 |
| AS4528 - TC - 04 | 201.29 | 12.55 | 6.33 | 79 | 3780 | 47.6 | 50.11 | 61.39 | 22.51 |
| AS4528 - TC - 05 | 200.86 | 12.52 | 6.24 | 78 | 3840 | 49.2 | 50.08 | 56.52 | 12.86 |
| AS4528 - TC - 06 | 201.73 | 12.52 | 6.24 | 78 | 3790 | 48.5 | 50.17 | 60.66 | 20.91 |
| Mean | | | | | | 48.1 (0.84) | | | 18.3 (4.6) |
| (Standard deviation) | | | | | | | | | |

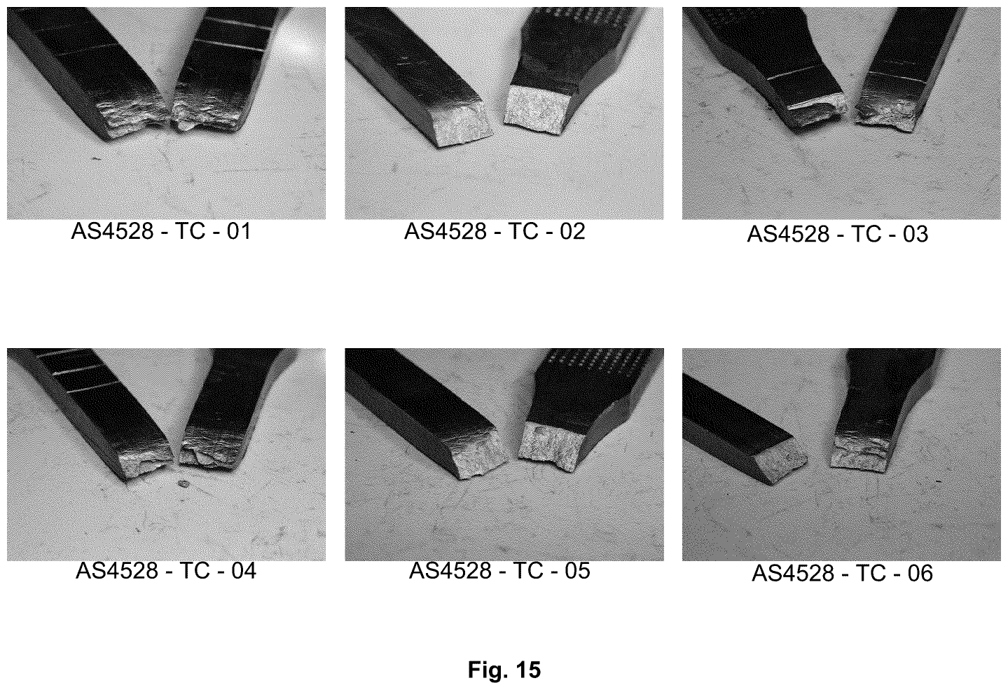

FIG. 15 shows photographs of the calcium-tin alloy tension test specimens, after testing.

### Antimonial Alloy Test Specimens

FIG. 13 shows a graph of tensile stress as a function of displacement for the antimonial alloy tension test specimens. Table 16 summarises dimensions and tension test results for antimonial alloy tension test specimens. The mean ultimate tensile strength (UTS) was 51.4 MPa, having a standard deviation of 7.8 MPa (i.e. greater variability than for the calcium-tin alloy tension test specimens). Elongation to failure was 7.2%, having a standard deviation of 2.9% (i.e. relatively less elongation but also less variability than for the calcium-tin alloy tension test specimens).

TABLE 16
Dimensions and tension test results for antimonial alloy tension test specimens.

| | | | | | | | Original | Final | |
|---|---|---|---|---|---|---|---|---|---|
| Test | | | | | | | Gauge | Gauge | |
| specimen | Length | Width | Thickness | CSA | Load | UTS | Length | Length | Elongation |
| No. | (mm) | (mm) | (mm) | (mm²) | (N) | (MPa) | (mm) | (mm) | (%) |
| AS4528 - AN - 01 | 202.60 | 12.43 | 8.36 | 104 | 6310 | 60.7 | 50.07 | 54.08 | 8.01 |
| AS4528 - AN - 02 | 201.50 | 12.77 | 7.38 | 94 | 4680 | 49.7 | 50.04 | 55.62 | 11.15 |
| AS4528 - AN - 03 | 199.70 | 12.70 | 7.64 | 97 | 4420 | 45.6 | 50.13 | 55.16 | 10.03 |
| AS4528 - AN - 04 | 201.13 | 12.35 | 8.31 | 103 | 6310 | 61.5 | 50.04 | 52.46 | 4.84 |
| AS4528 - AN - 05 | 201.62 | 12.56 | 8.24 | 103 | 4560 | 44.1 | 50.16 | 52.56 | 4.78 |
| AS4528 - AN - 06 | 201.06 | 12.54 | 7.44 | 93 | 4350 | 46.6 | 50.08 | 52.41 | 4.65 |
| Mean | | | | | | 51.4 (7.8) | | | 7.2 (2.9) |
| (Standard deviation) | | | | | | | | | |

Lead alloys including antimony are generally more brittle than other lead alloys, hence resulting in the greater variability of the UTS and lower elongation than for the calcium-tin alloy tension test specimens.

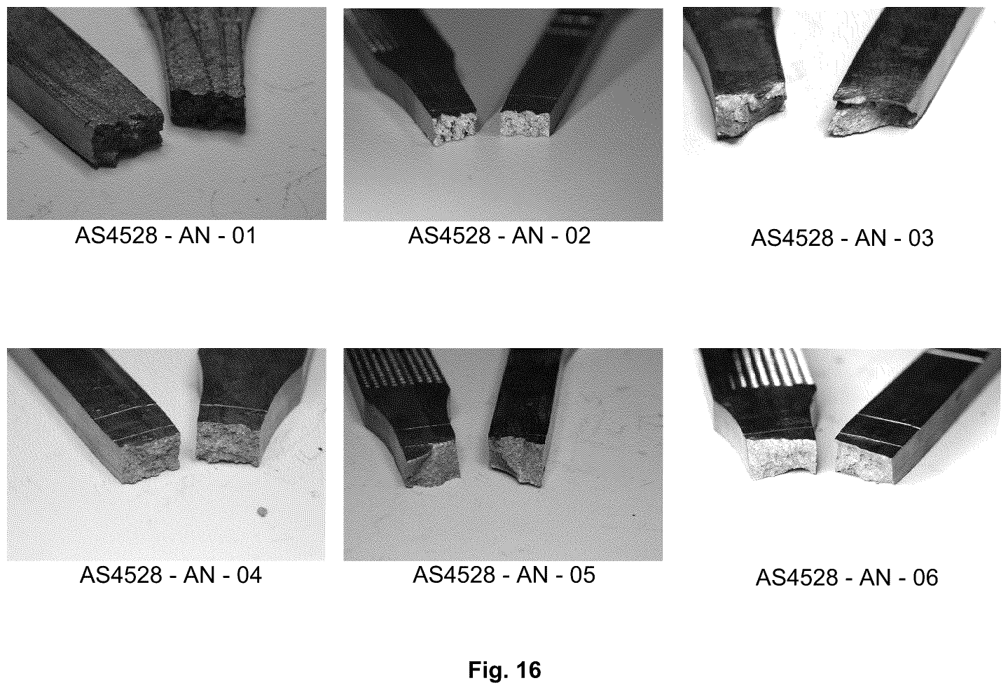

FIG. 16 shows photographs of the antimonial alloy tension test specimens, after testing.

### Welded Specimens

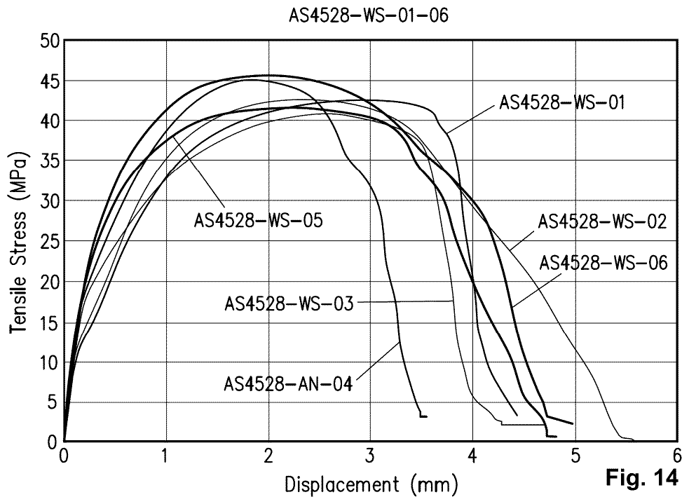

FIG. 14 shows a graph of tensile stress as a function of displacement of welds according to an exemplary embodiment of the first metal 10 of FIG. 12 and the second metal 20 of FIG. 13. Table 17 summarises dimensions and tension test results for the welded tension test specimens. The mean ultimate tensile strength (UTS) was 41.1 MPa, having a standard deviation of 2.0 MPa (i.e. lower than for the calcium-tin alloy tension test specimens and for the antimony alloy tension test specimens). Elongation to failure was 7.4%, having a standard deviation of 1.2% (i.e. about the same elongation as for the antimony alloy tension test specimens but also less variability).

TABLE 17
Dimensions and tension test results for welded tension test specimens.

| | | | | | | | Original | Final | |
|---|---|---|---|---|---|---|---|---|---|
| Test | Overall | | | | | | Gauge | Gauge | |
| specimen | Length | Width | Thickness | CSA | Load | UTS | Length | Length | Elongation |
| No. | (mm) | (mm) | (mm) | (mm²) | (N) | (MPa) | (mm) | (mm) | (%) |
| AS4528 - WS - 01 | 196.54 | 12.59 | 6.32 | 80 | 3190 | 40.1 | 50.20 | 53.62 | 6.81 |
| AS4528 - WS - 02 | 197.86 | 12.54 | 6.25 | 78 | 3190 | 40.7 | 50.23 | 54.25 | 8.00 |
| AS4528 - WS - 03 | 196.13 | 12.58 | 6.32 | 80 | 3090 | 38.9 | 50.11 | 53.78 | 7.32 |
| AS4528 - WS - 04 | 195.66 | 12.60 | 6.37 | 80 | 3500 | 43.6 | 50.23 | 52.93 | 5.38 |
| AS4528 - WS - 05 | 196.34 | 12.53 | 6.26 | 78 | 3130 | 39.9 | 50.16 | 54.26 | 8.17 |
| AS4528 - WS - 06 | 194.46 | 12.51 | 6.27 | 78 | 3430 | 43.7 | 50.17 | 54.53 | 8.69 |
| Mean | | | | | | 41.1 (2.0) | | | 7.4 (1.2) |
| (Standard deviation) | | | | | | | | | |

Failure of the welded tension test specimens was in the antimony alloy, adjacent to the weld. Nevertheless, the tension test properties of the weld metal are comparable with that of the antimony alloy and meet acceptance criteria for lead anodes for electrowinning, for example.

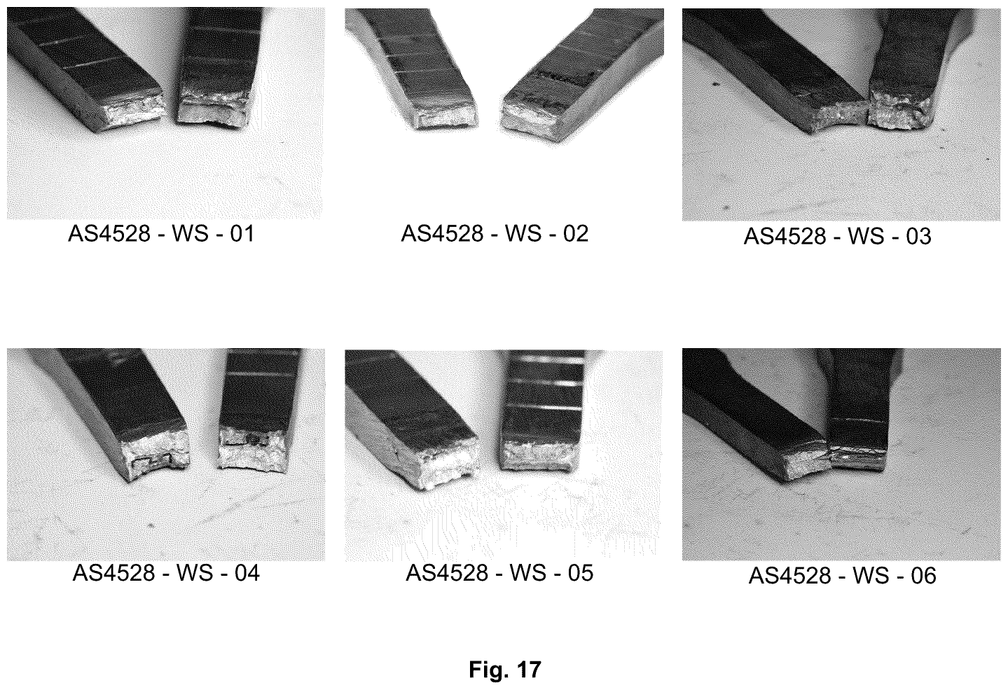

FIG. 17 shows photographs of the weld tension test specimens, after testing.

Although a preferred embodiment has been shown and described, it will be appreciated by those skilled in the art that various changes and modifications might be made without departing from the scope of the invention, as defined in the appended claims and as described above.

### PAW-DC Welding

PAW DC welding was performed using a Fronius® PlasmaModule 10®, for welding of lead alloy sheet for guttering and downpipes, for example, having a nominal thickness of 2 mm. The first metal 10 has a composition of Pb-1.5 wt. % Sn-0.7 wt. % Ca (referred to as calcium-tin alloy or TC) and a thickness of 2 mm. The second metal 20 has a composition of Pb-4.0 wt. % Sb (referred to as antimonial alloy or 4% ANT) and a thickness of 2 mm. Closed (maximum 0.2 mm gap) square butt joints J between the first metal 10 and the second metal 20 were prepared and the prepared joints J were fused autogenously, by welding from one side (i.e. single welded, closed butt joints) in a 1G position. An earthing electrode was positioned at the underside of the joint J, to control direction of the plasma arc and to provide a backing strip. PAW DC was performed at a speed of 3 mm s⁻¹ at a pulsed current in a range from 4 to 10 A. Unless specified otherwise, default parameters were used. Pureshield Argon at a flow rate of 0.6 to 1 L min⁻¹ was used, with the gas nozzle about 2 to 3 mm away from the metal. Electrode diameter was 1.5 mm.

PAW DC welding at similar conditions performed successfully also for lead alloys having a thickness in a range from 2 to 12 mm (double sided for thicknesses greater than about 6 mm).

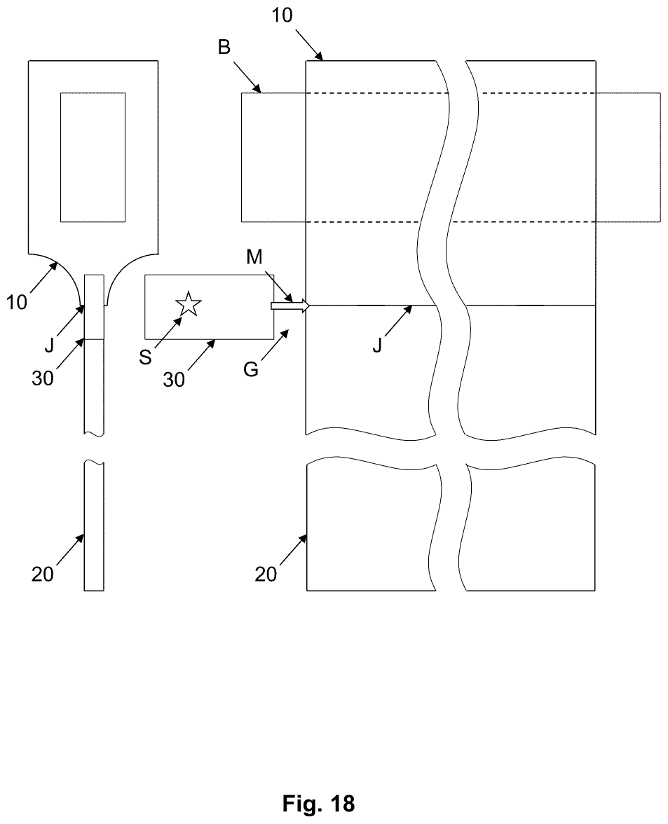

FIG. 18 schematically depicts a joint J for a method according to an exemplary embodiment, generally as described with respect to FIG. 11A. The method is of joining a first metal 10 and a second metal 20, wherein the first metal 10 comprises Pb in an amount of at least 50 wt. % by weight of the first metal 10, the method comprising: fusing the first metal 10 and the second metal 20 using non-consumable electrode arc welding; wherein fusing the first metal 10 and the second metal 20 using the non-consumable electrode arc welding comprises: starting S an arc of the non-consumable electrode arc welding on a third metal 30; and moving M the started arc from the third metal 30 to the first metal 10 and/or to the second metal 20.

As described with respect to FIG. 11A, GTAW DC and AC welding was performed using a TWECO® ARCMASTER® 301TS, for welding of an anode blade lead alloy 10 (i.e. a first metal), to a lead alloy coated anode bar, comprising a copper bar B having the lead alloy 20 (i.e. a second metal) coated thereon. The first metal 10 has a composition of Pb-1.5 wt. % Sn-0.08 wt. % Ca (referred to as calcium-tin alloy or TC) and a thickness of 6 mm. The second metal 20 has a composition of Pb-5.0 wt. % Sb (referred to as antimonial alloy or 5% ANT) and a thickness of 8 mm at the joint. During welding, some metal tends to flow from the relatively thicker second metal, thereby avoiding use of additional filler, for example. Closed (maximum 0.5 mm gap) square butt joints J between the first metal 10 and the second metal 20 were prepared by machining and the prepared joints J were fused autogenously, by welding from both sides (i.e. double welded, closed butt joints) in a 1G position generally according to the parameters of Tables 13A to 13C, the parameters having the meanings generally according to Tables 11 and 12 and as described previously. Unless specified otherwise, default parameters were used. The torch was held and moved using a first industrial robot (i.e. automated). Throughput was 15 to 20 such double welded 1 m long welds per hour, with manual set up of joints. Fully automating the welding, using industrial robots, will increase throughput to about 30 to 40 such double welded 1 m long welds per hour. This compares with 3 to 4 such double welded 1 m long welds per hour by manual lead burning by experienced welders.

In contrast to as described with respect to FIG. 11A, semi-circular notches are not provided at the start end and the stop end of the joint J.

In this example, the third metal 30 is electrically coupled to the first metal 10 and the third metal 30 is electrically coupled to the second metal 20, for example via an earth lead, a backing plate and/or a substrate, such as a welding table.

In this example, the first metal 10 and the third metal 30 are mutually spaced apart and/or the second metal 20 and the third metal 30 are mutually spaced apart, by a gap G in a range from 10 mm to 75 mm, for example 30 mm, 40 mm or 50 mm.

In this example, the third metal 30 is mild steel.

In this example, the third metal 30 and the first metal 10 are different. In this example, the third metal 30 and the second metal 20 are different.

In this example, the method comprises melting the third metal 30.

In this example, a ratio of a rate of non-consumable electrode arc welding of the third metal 30 to a rate of non-consumable electrode arc welding of the first metal 10 and the second metal 20 is about 1:1.

In this example, a ratio of a rate of moving the started arc from the third metal 30 to the first metal 10 and to the second metal 20 (of 100 mm/s) to a rate of non-consumable electrode arc welding of the first metal 10 and the second metal 20 (of 36 mm/s) is in a range from 10:1 to 2:1.

In this example, moving the started arc from the third metal 30 to the first metal 10 and/or to the second metal 20 comprises raising the started arc from the third metal 30, moving the started arc from the third metal to the first metal and/or to the second metal, across the gap G, and lowering the started arc to the first metal 10 and/or to the second metal 20. Attention

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims and drawings), and/or all of the steps of any method or process so disclosed, may be combined in any combination, except combinations where at most some of such features and/or steps are mutually exclusive.

Each feature disclosed in this specification (including any accompanying claims, and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims and drawings), or to any novel one, or any novel combination, of the steps of any method or process so disclosed.

1. A method of joining a first metal and a second metal, wherein the first metal comprises Pb in an amount of at least 50 wt. % by weight of the first metal, the method comprising:
fusing the first metal and the second metal using non-consumable electrode arc welding;
wherein fusing the first metal and the second metal using the non-consumable electrode arc welding comprises:
starting an arc of the non-consumable electrode arc welding on a third metal; and
moving the started arc from the third metal to the first metal and/or to the second metal.

2. The method according to claim 1, wherein the third metal is electrically coupled to the first metal and/or wherein the third metal is electrically coupled to the second metal.

3. The method according to claim 1, wherein the first metal and the third metal are mutually spaced apart and/or wherein the second metal and the third metal are mutually spaced apart.

4. The method according to claim 1, wherein the third metal comprises Pb in an amount of at most 25 wt. %.

5. The method according to claim 1, wherein the third metal comprises and/or is: a steel; an aluminium alloy; a magnesium alloy; a copper alloy; and/or a titanium alloy.

6. (canceled)

7. The method according to claim 1, wherein a ratio of a rate of non-consumable electrode arc welding of the third metal to a rate of non-consumable electrode arc welding of the first metal and the second metal is in a range from 10:1 to 1:10.

8. The method according to claim 1, wherein a ratio of a rate of moving the started arc from the third metal to the first metal and/or to the second metal to a rate of non-consumable electrode arc welding of the first metal and the second metal is in a range from 50:1 to 1:1.

9. The method according to claim 1, wherein the first metal comprises Pb in an amount of at least 75 wt. %, and/or wherein the second metal comprises Pb in an amount of at least 50 wt. % by weight of the second metal.

10. The method according to claim 1, wherein the first metal and/or the second metal consists of:
Ag in an amount from 0.0 to 2 wt. %;
Ca in an amount from 0.0 to 1 wt. %;
Sb in an amount from 0.0 to 25 wt. %;
Sn in an amount from 0.0 to 10 wt. %; and
balance Pb and unavoidable impurities.

11. The method according to claim 1, wherein the first metal and/or the second metal is according to UNS L50000 to L50099, UNS L50100 to L50199, UNS L54000 to L55099, UNS L52500 to L53799 or L50700 to L50899.

12. The method according to claim 1, wherein the method comprises preparing a butt joint between the first metal and the second metal, and wherein fusing the first metal and the second metal comprises fusing the prepared joint.

13. The method according to claim 1, wherein the non-consumable electrode arc welding comprises non-consumable electrode arc welding the first metal and the second metal without welding backing or comprises non-consumable electrode arc welding the first metal and the second metal in a flat position.

14. (canceled)

15. The method according to claim 1, wherein the non-consumable electrode arc welding comprises non-consumable electrode arc welding at a rate of from 1 to 100 mm s⁻¹.

16. The method according to claim 1, wherein the non-consumable electrode arc welding comprises providing a protective atmosphere comprising, substantially comprising, essentially comprising or consisting of Ar and unavoidable impurities, or comprising, substantially comprising, essentially comprising or consisting of Ar+1 to 5% H₂ and unavoidable impurities.

17. The method according to claim 1, wherein the non-consumable electrode arc welding comprises using a thoriated tungsten electrode, comprising from 1.7 to 2.2 wt. % thorium, having a diameter in a range from 1.0 mm to 3.2 mm, a diameter at tip in a range from 0.125 mm to 1.5 mm, a taper length of from 1.5 to 3 times the diameter, a constant included angle in a range from 12° to 90°, and/or a pointed or a truncated tip.

18. (canceled)

19. The method according to claim 1, wherein fusing the first metal and the second metal comprises autogenous fusing.

20. The method according to claim 1, wherein the non-consumable electrode arc welding comprises single pass welding or current control welding.

21. The method according to claim 1, wherein the non-consumable electrode arc welding is gas tungsten arc welding or plasma arc welding.

22. (canceled)

23. A component provided, at least in part, by joining according to the method of claim 1.

24. (canceled)

25. An apparatus for joining a first metal and a second metal, wherein the first metal comprises Pb in an amount of at least 50 wt. % by weight of the first metal, the apparatus comprising:
a non-consumable electrode arc welding unit configured to perform the method according to claim 1.
